(19) United States
(12) Patent Application Publication
(10) Pub. No.: US 2008/0098239 A1
(43) Pub. Date: Apr. 24, 2008

(54) STORAGE MEDIUM CONTROL METHOD

(75) Inventors: Hiroyuki WADA, Osaka (JP); Kotaro FUKAWA, Kyoto (JP); Atsushi OIDA, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/871,486

(22) Filed: Oct. 12, 2007

(30) Foreign Application Priority Data
Oct. 18, 2006 (JP) 2006-284373
May 15, 2007 (JP) 2007-129806

(51) Int. Cl. H04L 9/32

(52) U.S. Cl. 713/193

(57) ABSTRACT

A storage medium control apparatus capable of improving the processing performance, while protecting copyright protection information in a security mode, includes: a secure resource which executes mutual authentication processing with an authentication area of a storage medium, and performs encryption or decryption of data; a normal resource which sends or receives data to or from the storage medium; an encryption control unit which performs encryption or decryption of data by controlling the secure resource in the secure mode; a storage medium control unit which sends or receives data encrypted by the encryption control unit or data decrypted by the encryption control unit to or from the storage medium by controlling the normal resource, in the secure mode; and a storage medium processing unit which performs predetermined processing for the data decrypted by the encryption control unit or unencrypted data read from the storage medium by the storage medium control unit.

### BACKGROUND OF THE INVENTION

(1) Field of the Invention

The present invention relates to a storage medium control method for controlling access to a storage medium including an authentication area which can be accessed after executing a mutual authentication processing and a normal area which can be accessed without executing the mutual authentication processing.

(2) Description of the Related Art

Recently, a necessity for copyright protection of contents has been increased. In terrestrial digital broadcasting and the like, contents distribution including right information, which is described later, has been performed. When such contents are recorded in a storage medium, it is necessary to record the right information together with the contents.

The “right information” includes information which is important to protect copyright, such as information about whether or not the contents can be moved, copied or reproduced and information about the number of times the contents can be removed, copied or reproduced, and the like. Therefore, various equipment for handling such contents is required to handle them in a manner that the right information is not falsified.

Information required to be protected, such as the right information, is stored in an “authentication area” of a storage medium, and it is not possible to access data stored in the authentication area until mutual authentication is performed between the storage medium and the various equipment. Meanwhile, other information is stored in a “normal area” of the storage medium which can be accessed without a necessity of mutual authentication.

There has been proposed, as a data access apparatus for accessing the storage medium, a data processing apparatus in which a monitor program switches between a “secure mode” enabling access to secure data and secure applications required to be protected and a “normal mode” in which the secure data and the secure applications cannot be accessed, and executes the mode (for example, see Japanese Unexamined Patent Application Publication No. 2005-182774).

The data processing apparatus described in Japanese Unexamined Patent Application Publication No. 2005-182774 reproduces the contents while protecting the right information by switching between the normal mode and the secure mode to access the storage medium.

However, a processing, such as a save/restore processing, of security information is required to switch between the secure mode and the normal mode. Furthermore, in the data processing apparatus described in Japanese Unexamined Patent Application Publication No. 2005-182774, switching between both modes caused by alternately accessing a secure resource and a normal resource frequently occurs, especially in copyright protection processing such as the mutual authentication or access to the authentication area. Therefore, there is a problem that the processing performance significantly deteriorates. Note that the “secure resource” refers to hardware for executing the mutual authentication processing or performing encryption or decryption of data, which can operate only in the secure mode. On the other hand, the “normal resource” refers to hardware for writing and reading of data to and from the storage medium, which can operate only in the normal mode.

### SUMMARY OF THE INVENTION

The present invention has been made to solve the above problems, and its object is to provide a storage medium control method which makes it possible to improve a processing performance while protecting copyright protection information in a secure mode.

A storage medium control method according to an aspect of the present invention is a storage medium control method for controlling data communication with a storage medium while switching between a secure mode in which use of a secure resource is permitted and a normal mode in which only use of a normal resource is permitted. The storage medium includes: an authentication area which can be accessed after mutual authentication is performed; and a normal area which can be accessed without performing the mutual authentication. The secure resource is a module which executes mutual authentication processing with the authentication area of the storage medium, and the normal resource is a module which sends or receives data to or from the storage medium. The storage medium control method includes a secure-mode data sending/receiving step of sending or receiving data to or from the storage medium by controlling of the normal resource without switching to the normal mode by a storage medium control unit which controls the storage medium, in the secure mode.

According to this configuration, it is possible to directly access the normal resource even in the secure mode. Therefore, it is not necessary to perform switching to the normal mode when accessing the data stored in the storage medium in the secure mode. Accordingly, it is possible to reduce the number of times of switching between the secure mode and the normal mode. Furthermore, it is possible to perform a processing without handling copyright protection information (right information) on the normal mode side. Accordingly, it is possible to improve the processing performance while protecting the copyright protection information (right information) in the security mode.

It is preferable that the secure resource further execute the mutual authentication processing with the authentication area of the storage medium. The secure-mode data sending/receiving step includes a secure-mode encrypted/decrypted data sending/receiving step of sending or receiving the data to or from the storage medium by controlling of the normal resource without switching to the normal mode by the storage medium control unit which controls the storage medium, in the secure mode, the data being the data encrypted by an encryption control unit which controls encryption or decryption of data or the data to be decrypted by an encryption control unit. The storage medium control method further includes: a secure-mode encryption/decryption step of encrypting or decrypting data by controlling of the secure resource by the encryption control unit, in the secure mode; and a secure-mode predetermined processing execution step of executing predetermined processing, by a storage medium processing unit, for the data decrypted in said secure-mode encrypting/decrypting step or unencrypted data read from the storage medium in said secure-mode encrypted/decrypted data sending/receiving step, in the secure mode.

The storage medium control unit includes: a storage medium authentication area control unit which controls the authentication area of the storage medium in the secure mode; and a storage medium normal area control unit which controls the normal area of the storage medium in the normal mode. The storage medium processing unit includes: a storage medium authentication area processing unit which executes predetermined processing for data in the secure mode; and a storage medium normal area processing unit which executes predetermined processing for data in the normal mode. In the secure-mode encrypted/decrypted data sending/receiving step, the data is sent to or received from the authentication area of the storage medium by controlling of the normal resource without switching to the normal mode by the storage medium authentication area control unit, in the secure mode, the data being the data encrypted by the encryption control unit or the data to be decrypted by the encryption control unit. In the secure-mode predetermined processing execution step, the storage medium authentication area processing unit executes the predetermined processing for the data decrypted in the secure-mode encryption/decryption step or the unencrypted data read from the authentication area of the storage medium in the secure-mode encrypted/decrypted data sending/receiving step, in the secure mode. The storage medium control method further includes: a normal-mode data sending/receiving step of sending or receiving data to and from the normal area of the storage medium by controlling of the normal resource by the storage medium normal area control unit, in the normal mode; and a normal-mode predetermined processing execution step of executing predetermined processing, by the storage medium normal area processing unit, for the data sent or received in said normal-mode data sending/receiving step, in the normal mode.

According to this configuration, it is further possible to perform data access to the normal area and data access to the authentication area while sharing the same normal resource under the control from the normal mode side and the control from the secure mode side. Therefore, it is not necessary to switch to the normal mode when accessing the data stored in the storage medium in the secure mode, and it is possible to reduce the number of times of switching between the secure mode and the normal mode. Thereby, the processing can be speeded up.

Furthermore, it is usually possible to easily add the storage medium authentication area control unit and the storage medium authentication area processing unit while avoiding a modification of the storage medium normal area control unit and the storage medium normal area processing unit configured by an existing general-purpose OS as much as possible.

The storage medium control method further includes: an initialization step of acquiring storage medium information including at least address information, area size or access size about the storage medium by executing initialization processing of the storage medium by the storage medium normal area control unit; and a notification step of notifying the storage medium authentication area control unit of the storage medium information acquired in said initialization step. In the secure-mode encrypted/decrypted data sending/receiving step, the data is sent to or received from the authentication area of the storage medium by controlling of the normal resource using the storage medium information without switching to the normal mode by the storage medium authentication area control unit, in the secure mode, the data being the data encrypted by the encryption control unit or the data to be decrypted by the encryption control unit.

According to this configuration, it is possible to access the storage medium on the normal mode side and on the secure mode side simply by performing an initialization of the storage medium only on the normal mode side.

The storage medium control method further includes: an initialization step of acquiring storage medium information including at least address information, area size or access size about the storage medium by executing initialization processing of the storage medium, irrespective of whether or not the storage medium has already been executed, by the storage medium authentication area control unit, when transitioning to the secure mode. In the secure-mode encrypted/decrypted data sending/receiving step, the data is sent to or received from the authentication area of the storage medium by controlling of the normal resource using the storage medium information without switching to the normal mode by the storage medium authentication area control unit, in the secure mode, the data being the data encrypted by the encryption control unit or the data to be decrypted by the encryption control unit.

According to this configuration, it is possible for the storage medium authentication area control unit to acquire the storage medium information independent from the storage medium normal area control unit. Therefore, the operation is possible without synchronizing the storage medium normal area control unit and the storage medium authentication area control unit, so that the processing can be speeded up.

The storage medium control method further includes: an initialization step of acquiring storage medium information including at least address information, area size or access size about the storage medium by executing initialization processing of the storage medium by the storage medium normal area control unit; an encryption step of encrypting, using a secret key, the storage medium information acquired in said initialization step; a notification step of notifying the storage medium authentication area control unit of the encrypted storage medium information, the encrypted storage medium information being the storage medium information that has been encrypted; and a decryption step of decrypting, using the secret key, the encrypted storage medium information by the storage medium authentication area control unit. In the secure-mode encrypted/decrypted data sending/receiving step, the data is sent to or received from the authentication area of the storage medium by controlling of the normal resource using the storage medium information without switching to the normal mode by the storage medium authentication area control unit, in the secure mode, the data being the data encrypted by the encryption control unit or the data decrypted by the encryption control unit.

According to this configuration, the storage medium information is encrypted. Therefore, it is possible to improve the strength of security of data in sending and receiving the data.

The storage medium control method further includes: a step of judging, by the storage medium normal area processing unit, whether or not the storage medium normal area control unit is accessing the normal area of the storage medium; a step of permitting the storage medium authentication area control unit to use the normal resource when it is judged that the normal area of the storage medium is not being accessed; a step of judging, by the storage medium authentication area processing unit, whether or not the storage medium authentication area control unit is accessing the authentication area of the storage medium; and a step of permitting the storage medium normal area control unit to use the normal resource when it is judged that the authentication area of the storage medium is not being accessed.

According to this configuration, it is possible to perform an exclusive control so that the storage medium normal area control unit and the storage medium authentication area control unit do not access the storage medium at the same time.

The storage medium control method further includes: a step of judging a condition of access to the storage medium by referencing of storage medium access data indicating the condition of access to the storage medium by the storage medium authentication area control unit, the storage medium access data allowing referencing from both the storage medium authentication area control unit and the storage medium normal area control unit; a step of permitting the storage medium authentication area control unit to use the normal resource when the storage medium authentication area control unit judges that the storage medium is not being accessed; a step of judging a condition of access to the storage medium by referencing of the storage medium access data by the storage medium normal area processing unit; and a step of permitting the storage medium normal area control unit to use the normal resource when the storage medium normal area control unit judges that the storage medium is not being accessed.

According to this configuration, it is possible to perform the exclusive control so that the storage medium normal area control unit and the storage medium authentication area control unit do not access the storage medium at the same time.

The storage medium control method further includes: a step of resetting the normal resource by the storage medium normal area control unit or the storage medium authentication area control unit, each time mode switching between the secure mode and the normal mode occurs; and a step of setting a set value including access bit width for accessing the storage medium or access size of data sent to or received from the storage medium for the normal resource by the storage medium normal area control unit or the storage medium authentication area control unit, the storage medium normal area control unit or the storage medium authentication area control unit resetting the normal resource. In the secure-mode encrypted/decrypted data sending/receiving step, the data is sent to or received from the authentication area of the storage medium by controlling of the normal resource without switching to the normal mode, in accordance with the set value set for the normal resource, by the storage medium authentication area control unit, in the secure mode, the data being the data encrypted by the encryption control unit or the data to be decrypted by the encryption control unit. In the normal-mode data sending/receiving step, the data is sent to or received from the normal area of the storage medium by controlling of the normal resource, in accordance with the set value set for the normal resource, by the storage medium normal area control unit, in the normal mode.

According to this configuration, each of the storage medium normal area control unit and the storage medium authentication area control unit resets and sets set values for the normal resource. Therefore, the storage medium authentication area control unit can access the storage medium without depending on the set values of the normal resource set by the storage medium normal area control unit, and the storage medium normal area control unit can access the storage medium without depending on the set values of the normal resource set by the storage medium authentication area control unit.

The storage medium control method further includes: a step of backing up, in a predetermined memory area, a set value including access bit width for accessing the storage medium or access size of data sent to or received from the storage medium when switching from the normal mode to the secure mode, the storage medium being used by the storage medium normal area control unit; a step of setting the set value to be used by the storage medium authentication area control unit for the normal resource after the set value is backed up in the predetermined memory area; and a step of setting the set value to be used by the storage medium normal area control unit for the normal resource when exiting the secure mode, the set value being backed up in the predetermined memory area. In the secure-mode encrypted/decrypted data sending/receiving step, the data is sent to or received from the authentication area of the storage medium by controlling of the normal resource without switching to the normal mode, in accordance with the set value set for the normal resource, by the storage medium authentication area control unit, in the secure mode, the data being the data encrypted by the encryption control unit or the data to be decrypted by the encryption control unit. In the normal-mode data sending/receiving step, the data is sent to or received from the normal area of the storage medium by controlling of the normal resource, in accordance with the set value set for the normal resource, by the storage medium normal area control unit, in the normal mode.

According to this configuration, it is not necessary to set the set values for a normal resource in the normal mode. Therefore, it is not necessary to modify an existing storage medium normal area control unit.

The normal resource is connected to a set value storage unit which is a module storing a set value including access bit width for accessing the storage medium or access size of data sent to or received from the storage medium, the set value being used when the normal resource accesses the storage medium. The storage medium control method further includes a step of setting the set value stored in the set value storage unit for each mode by the normal resource, each time mode switching between the normal mode and the secure mode occurs. In the secure-mode encrypted/decrypted data sending/receiving step, the data is sent to or received from the authentication area of the storage medium by controlling the normal resource without switching to the normal mode, in accordance with the set value set for the normal resource, by the storage medium authentication area control unit, in the secure mode, the data being the data encrypted by the encryption control unit or the data to be decrypted by the encryption control unit. In the normal-mode data sending/receiving step, data is sent to or received from the normal area of the storage medium by controlling of the normal resource, in accordance with the set value set for the normal resource, by the storage medium normal area control unit, in the normal mode.

According to this configuration, when the mode is switched, the normal resource reads the set values from the set value storage unit, which is hardware, and sets the set values. Therefore, it is possible to change the set values at a high speed with the switching of the mode.

The storage medium control method further includes: a step of judging whether or not access to the storage medium is a first access after resetting of the storage medium by the storage medium normal area processing unit, when the access to the storage medium occurs; a step of initializing the storage medium by the storage medium normal area processing unit when it is judged that the access is the first access after the resetting of the storage medium; and a step of notifying the storage medium authentication area control unit of storage medium access information when the normal mode is switched to the secure mode, the storage medium access information being identification information identifying the storage medium and obtained along with the initialization of the storage medium. In the secure-mode encrypted/decrypted data sending/receiving step, the data is sent to or received from the authentication area of the storage medium by controlling of the normal resource in accordance with the storage medium access information without switching to the normal mode by the storage medium authentication area control unit, in the secure mode, the data being the data encrypted by the encryption control unit or the data to be decrypted by the encryption control unit. It should be noted that the storage medium is reset when turning the power on or off, inserting or removing the storage medium, occurrence of an abnormal state, or the like takes place.

According to this configuration, when the mode is switched, it is possible to notify not the storage medium information but only the storage medium access information to the storage medium authentication area control unit. Therefore, the processing by the storage medium authentication area control unit can be speeded up.

The storage medium control method further includes a step of executing mutual authentication processing by the storage medium authentication area control unit, only when the mutual authentication processing with the authentication area of the storage medium has not succeeded at all after the resetting of the storage medium, with the authentication area of the storage medium, in the secure mode.

According to this configuration, it is possible to omit the second and subsequent mutual authentication processing. Therefore, the processing can be speeded up.

The storage medium control method further includes: a step of initializing the storage medium by the storage medium normal area control unit, each time a request to access the storage medium occurs; and a step of notifying the storage medium authentication area control unit of storage medium access information when the normal mode is switched to the secure mode, the storage medium access information being identification information for identifying the storage medium and obtained along with the initialization of the storage medium. In the secure-mode encrypted/decrypted data sending/receiving step, the data is sent to or received from the authentication area of the storage medium by controlling of the normal resource without switching to the normal mode, in accordance with the storage medium access information, by the storage medium authentication area control unit, in the secure mode, the data being the data encrypted by the encryption control unit or the data to be decrypted by the encryption control unit.

According to this configuration, the storage medium normal area control unit can always start processing after the storage medium is reset, and on the contrary, a storage medium authentication area control unit can always start a processing on the assumption that the storage medium has been reset. Thereby, the processing for judging reset of the storage medium is reduced, and the processing can be speeded up.

A storage medium control apparatus according to other aspect of the present invention is a storage medium control apparatus which controls data communication with a storage medium while switching between a secure mode in which use of a secure resource is permitted and a normal mode in which only use of a normal resource is permitted. The storage medium includes: an authentication area which can be accessed after mutual authentication is performed; and a normal area which can be accessed without performing the mutual authentication. The storage medium control apparatus includes: the secure resource which executes mutual authentication processing with the authentication area of the storage medium, and encryption or decryption of data; the normal resource which sends or receives data to or from the storage medium; an encryption control unit which executes encryption or decryption of data by controlling the secure resource in the secure mode; a storage medium control unit which sends or receives data to or from the storage medium by controlling of the normal resource without switching to the normal mode, in the secure mode, the data being the data encrypted by said encryption control unit or data to be decrypted by said encryption control unit; and a storage medium processing unit which executes predetermined processing for the data decrypted by the encryption control unit or unencrypted data read from the storage medium by the storage medium control unit, in the secure mode.

According to this configuration, it is possible to directly access the normal resource even in the secure mode. Therefore, it is not necessary to perform the switching to the normal mode when accessing the data stored in the storage medium in the secure mode. Accordingly, it is possible to reduce the number of times of switching between the secure mode and the normal mode. Furthermore, it is possible to perform the processing without handling the copyright protection information (right information) on the normal mode side. Accordingly, it is possible to improve the processing performance while protecting the copyright protection information (right information) in the security mode.

The storage medium control unit includes: a storage medium authentication area control unit which sends or receives data to or from the authentication area of the storage medium by controlling of the normal resource, in the secure mode, the data being the data encrypted by the encryption control unit or the data to be decrypted by the encryption control unit; and a storage medium normal area control unit which sends or receives data to or from the normal area of the storage medium by controlling of the normal resource, in the normal mode. The storage medium processing unit includes: a storage medium authentication area processing unit which executes predetermined processing for the data decrypted by the encryption control unit or unencrypted data read from the authentication area of the storage medium by the storage medium authentication area control unit, in the secure mode; and a storage medium normal area processing unit which executes predetermined processing for the unencrypted data read from the normal area of the storage medium by the storage medium normal area control unit, in the normal mode.

According to this configuration, it is further possible to perform the data access to the normal area and the data access to the authentication area while sharing the same normal resource under the control from the normal mode side and the control from the secure mode side. Therefore, it is not necessary to switch to the normal mode when accessing the data stored in the storage medium in the secure mode, and it is possible to reduce the number of times of switching between the secure mode and the normal mode. Thereby, the processing can be speeded up.

Furthermore, it is usually possible to easily add the storage medium authentication area control unit and the storage medium authentication area processing unit while avoiding the modification of the storage medium normal area control unit and the storage medium normal area processing unit configured by the existing general-purpose OS as much as possible.

The storage medium control apparatus further includes: an encoding processing unit which receives video/audio contents from the storage medium normal area control unit, analyzes an encoding format of the received video/audio contents, decodes the video/audio contents, and outputs video/audio data in particular data unit; and a video/audio reproduction unit which receives and reproduces the video/audio data outputted from the encoding processing unit in the particular data unit.

The storage medium control apparatus further includes: a video/audio recording unit which receives video/audio data in particular data unit; and an encoding processing unit which encodes the video/audio data received by the video/audio recording unit on the basis of a particular encoding format, and outputs the data to the storage medium normal area control unit.

According to the present invention, it is possible to provide the storage medium control method and the like capable of improving the processing performance while protecting the copyright protection information in the secure mode.

### Further Information about Technical Background to this Application

The disclosure of Japanese Patent Application No. 2006-284373 filed on Oct. 18, 2006 including specification, drawings and claims is incorporated herein by reference in its entirety.

The disclosure of Japanese Patent Application No. 2007-129806 filed on May 15, 2007 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing an aspect of utilization of a storage medium control system;

FIG. 2 is a functional block diagram showing a configuration of a storage medium control system according to a first embodiment;

FIGS. 3A to 3C are flowcharts showing control processing of a storage medium according to the first embodiment;

FIG. 4 is a functional block diagram showing a configuration of a storage medium control system according to a second embodiment;

FIGS. 5A to 5C are flowcharts showing a control processing of a storage medium according to the second embodiment;

FIGS. 6A and 6B are flowcharts showing a control processing of a storage medium according to a third embodiment;

FIG. 7 is a flowchart showing a control processing of a storage medium according to a first modification of the third embodiment;

FIGS. 8A and 8B are flowcharts showing a control processing of a storage medium according to a second modification of the third embodiment;

FIGS. 9A and 9B are flowcharts showing a control processing of a storage medium according to a fourth embodiment;

FIGS. 10A and 10B are flowcharts showing a control processing of a storage medium according to a modification of the fourth embodiment;

FIGS. 11A and 11B are flowcharts showing a control processing of a storage medium according to a fifth embodiment;

FIG. 12 is a flowchart showing a control processing of a storage medium according to a first modification of the fifth embodiment;

FIG. 13 is a functional block diagram showing a configuration of a storage medium control system according to a second modification of the fifth embodiment;

FIGS. 14A and 14B are flowcharts showing a control processing of a storage medium according to the second modification of the fifth embodiment;

FIGS. 15A and 15B are flowcharts showing a control processing of a storage medium according to a sixth embodiment;

FIGS. 16A and 16B are flowcharts showing a control processing of a storage medium according to a first modification of the sixth embodiment;

FIG. 17 is a flowchart showing a control processing of a storage medium according to a second modification of the sixth embodiment;

FIG. 18 is a diagram showing a configuration of a storage medium video and audio reproduction system according to an seventh embodiment; and

FIG. 19 is a diagram showing a configuration of a storage medium video and audio recording system according to an eighth embodiment.

### DESCRIPTION OF THE PREFERRED EMBODIMENTS

### First Embodiment

A storage medium control system according to a first embodiment of the present invention will be described with reference to drawings.

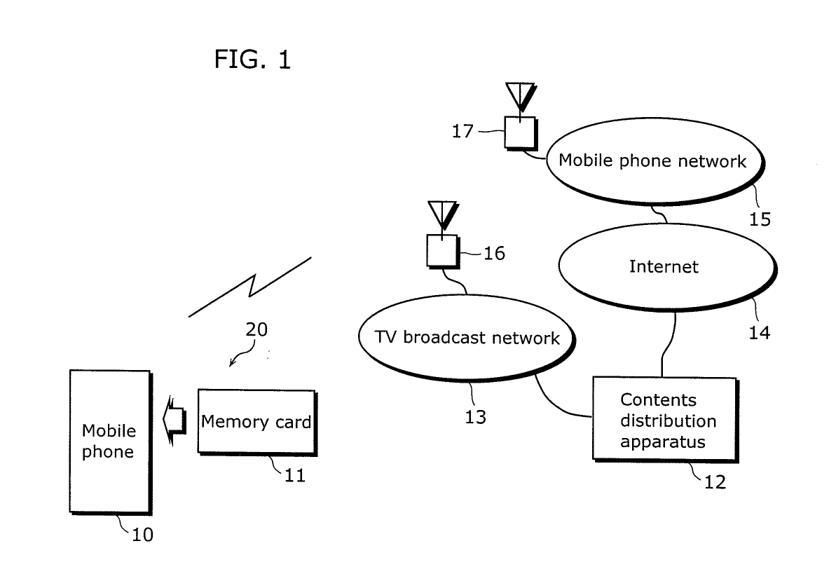

FIG. 1 is a diagram showing an aspect of utilization of the storage medium control system.

A storage medium control system 20 is provided with a mobile phone 10 and a copyright-protection-function-equipped memory card 11 to be mounted in the mobile phone 10.

The mobile phone 10 acquires an encryption key from the memory card 11 and sets it for the mobile phone 10. The mobile phone 10 acquires contents which have been encrypted (hereinafter referred to as “encrypted contents”) from the memory card 11. The mobile phone 10 decrypts the acquired video contents or audio contents and reproduces the decrypted video contents or audio contents.

Alternatively, the mobile phone 10 encrypts video contents or audio contents delivered from a contents distribution apparatus 12 via a TV broadcast network 13, the Internet 14, or a mobile phone network 15 and records the encrypted contents in the memory card 11 together with the encryption key.

Note that, though the memory card 11 is assumed to be the storage medium in FIG. 1, the storage medium for realizing the storage medium control system is not limited to a memory card. It may be any other storage medium, such as a Digital Versatile Disk (DVD), a Hard Disk (HD), or a Random Access Memory (RAM).

The mobile phone 10 is assumed to be a storage medium control apparatus which controls the storage medium. However, the storage medium control apparatus for realizing the storage medium control system is not limited to the mobile phone 10. It may be any other storage medium control apparatus, such as a TV set, a DVD recorder, or a digital still camera.

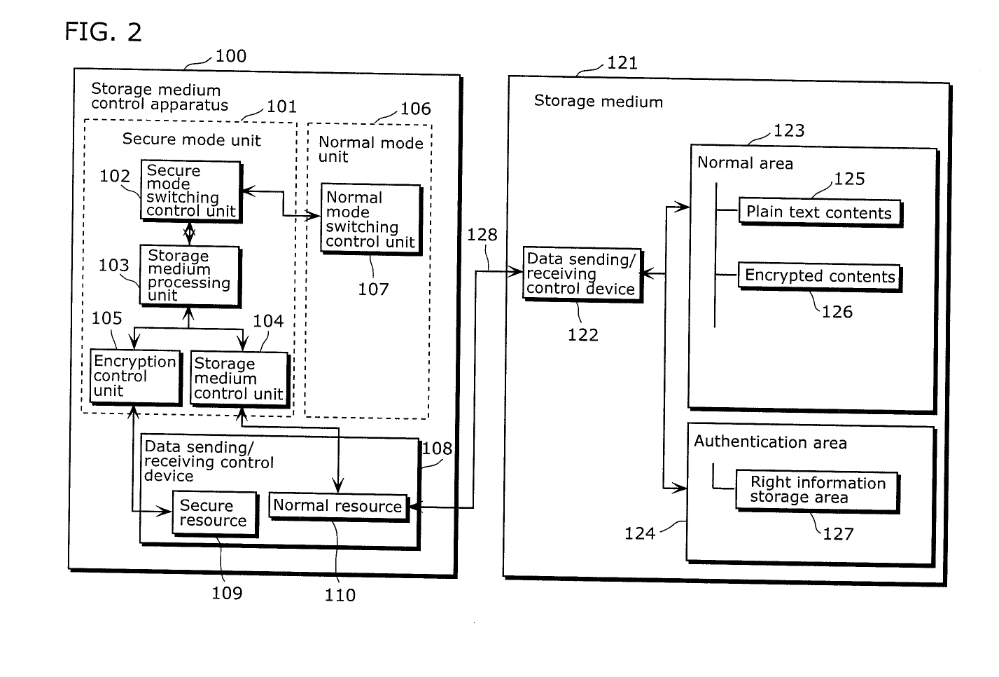

FIG. 2 is a functional block diagram showing a configuration of the storage medium control system 20.

The storage medium control system 20 is provided with a storage medium 121 and a storage medium control apparatus 100. The memory card 11 shown in FIG. 1 is an example of the storage medium 121, and the mobile phone 10 is an example of the storage medium control apparatus 100.

The storage medium 121 is a medium which stores data and is configured by a normal area 123, an authentication area 124, and a data sending/receiving control device 122.

The normal area 123 is a storage area which can be accessed without performing mutual authentication with the storage medium control apparatus 100, and it is a storage area for storing data including unencrypted plain text contents 125 and encrypted contents 126.

The authentication area 124 is a storage area which can be accessed after mutual authentication is performed with the storage medium control apparatus 100, and it includes a right information storage area 127 inside it. The right information storage area 127 is a storage area for storing right information about the encrypted contents 126 stored in the normal area 123.

The data sending/receiving control device 122 is a processing unit which performs input/output control of the data stored in the normal area 123 and the authentication area 124 on the basis of a data read or write request from the storage medium control apparatus 100.

The storage medium control apparatus 100 is an apparatus which reads and writes data to and from the storage medium 121, and it is provided with a normal mode unit 106, a secure mode unit 101, and a data sending/receiving control device 108.

The storage medium control apparatus 100 is provided with a common Central Processing Unit (CPU), a memory, and the like, and it realizes the normal mode unit 106 and the secure mode unit 101 described above by executing a program stored in the memory.

The data sending/receiving control device 108 is configured by hardware.

Note that, since other components are not directly related to the present invention, they are not shown, and a description thereof is omitted.

The data sending/receiving control device 108 is provided with a normal resource 110 and a secure resource 109.

The normal resource 110 is a processing unit for reading data from the storage medium 121 and writing data to the storage medium 121.

The secure resource 109 is a processing unit which performs the mutual authentication with the storage medium 121 using data specified by the normal resource 110. The secure resource 109 also decrypts the encrypted contents 126 read from the normal area 123. Furthermore, the secure resource 109 encrypts unencrypted contents which are used within the storage medium control apparatus 100.

The normal mode unit 106 is a processing unit realized by executing a general-purpose Operating System (OS) represented by Linux® on the CPU, and it is provided with a normal mode switching control unit 107.

The normal mode switching control unit 107 is a software module which performs a processing for switching between a normal mode and a secure mode, and it sends and receives data between the normal mode unit 106 and the secure mode unit 101.

Here, the “normal mode” refers to a mode in which the secure resource 109 cannot be accessed and in which only the normal resource 110 can be accessed.

The “secure mode” refers to a mode in which the secure resource 109 can be accessed. Note that, in the “secure mode” in the present embodiment, it is also possible to access the normal resource 110.

The secure mode unit 101 is a processing unit realized by executing a secure OS on the CPU, and it is provided with an encryption control unit 105, a storage medium control unit 104, a storage medium processing unit 103, and a secure mode switching control unit 102.

The encryption control unit 105 is a software module which controls the secure resource 109 to execute a mutual authentication processing between the storage medium 121 and the storage medium control apparatus 100, and to perform encryption and decryption of contents.

The storage medium control unit 104 is a software module which controls data writing to and data reading from the normal area 123 and the authentication area 124 inside the storage medium 121 via the normal resource 110, and controls the encryption control unit 105.

The storage medium processing unit 103 is a software module which performs access to the storage medium 121, mutual authentication between the storage medium 121 and the storage medium control apparatus 100, and encryption and decryption of contents data, via the storage medium control unit 104 and the encryption control unit 105.

The secure mode switching control unit 102 is a software module which switches between the normal mode and the secure mode, and sends and receives the data between the normal mode unit 106 and the secure mode unit 101.

Next, a control processing of the storage medium 121 from the secure mode unit 101 will be described.

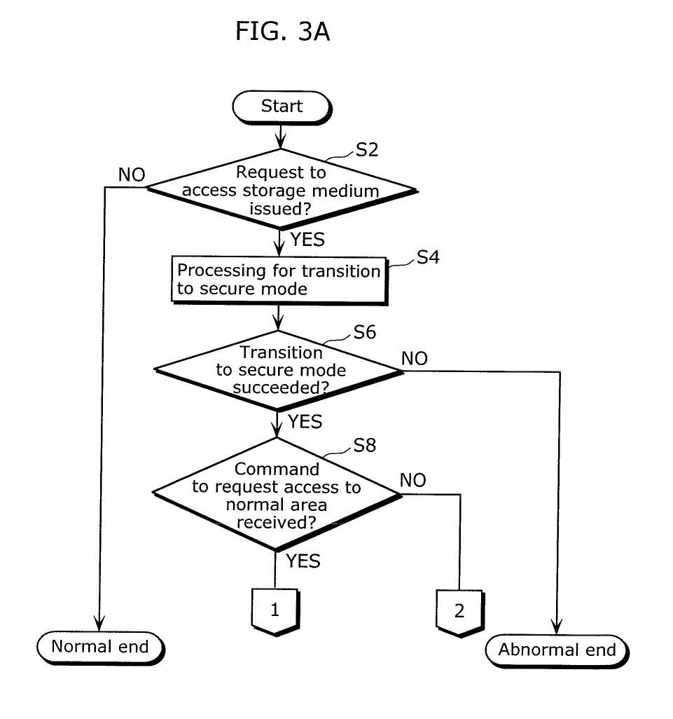

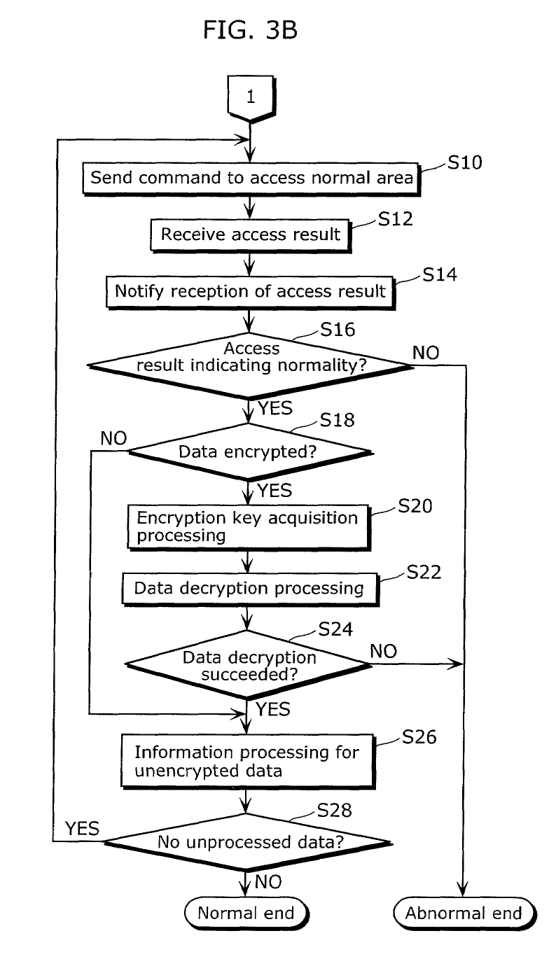

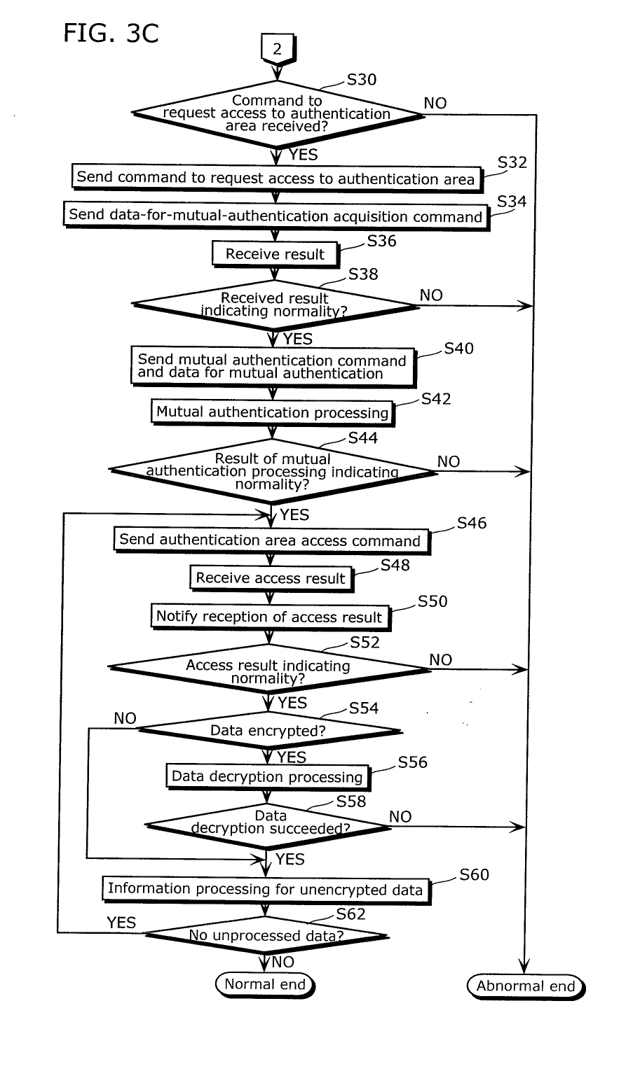

FIGS. 3A to 3C are flowcharts showing the control processing of the storage medium 121 from the secure mode unit 101.

As the scenes where it is assumed that the above processing is performed, various scenes are assumed, such as a case of inserting the memory card 11 into the mobile phone 10 to reproduce encrypted contents recorded in the memory card 11 and a case of inserting the memory card 11 into the mobile phone 10 to record the encrypted contents in the memory card 11. Note that timing of executing the above processing depends on the storage medium control apparatus 100 such as the mobile phone 10, and the processing may be executed at any timing.

When a request to access the storage medium 121 is issued by the storage medium control apparatus 100 (S2: YES), the normal mode switching control unit 107 sends a command to the secure mode switching control unit 102 to switch from the normal mode to the secure mode (S4). When a request to access the storage medium 121 is not issued (S2: NO), the processing normally ends.

When the secure mode switching control unit 102 receives the command from the normal mode switching control unit 107, it is assumed that the transition from the normal mode to the secure mode has succeeded (S6: YES). When the secure mode switching control unit 102 cannot receive the command from the normal mode switching control unit 107, it is assumed that the transition to the secure mode has failed (S6: NO), and the storage medium control apparatus 100 abnormally ends.

When transition to the secure mode has succeeded (S6: YES), the secure mode switching control unit 102 performs a processing on the basis of the command received from the normal mode switching control unit 107.

When the received command is a command to access the normal area 123 of the storage medium 121 (S8: YES), the secure mode switching control unit 102 sends, to the storage medium processing unit 103, a command to request access to the normal area 123 (S10).

After confirming that the received command is a command to request the access to the normal area 123, the storage medium processing unit 103 sends, to the storage medium control unit 104, the command to request the access to the normal area 123 (S10). After confirming that the received command is a command to access the normal area 123, the storage medium control unit 104 controls the normal resource 110 of the data sending/receiving control device 108 to send, to the storage medium 121 via a data bus 128, the command to access the normal area 123 (S10).

After the data sending/receiving control device 122 receives the access command sent from the normal resource 110, and the storage medium 121 confirms that the received access command is a command to access the normal area 123, the storage medium 121 accesses the normal area 123 and sends the access result to the normal resource 110 via the data sending/receiving control device 122 and the data bus 128.

The normal resource 110 receives the access result from the data sending/receiving control device 122 (S12). The normal resource 110 which has received the access result notifies the storage medium control unit 104 that the access to the normal area 123 has completed and it has received the access result (S14).

When the result of the access to the normal area 123 received from the normal resource 110 by the storage medium control unit 104 indicates success (S16: YES), the processing proceeds to S18. When the result of the access to the normal area 123 received from the normal resource 110 indicates failure (S16: NO), the storage medium control apparatus 100 abnormally ends.

When the data of the normal area 123 read at S12 is the encrypted contents 126 (S18: YES), the storage medium processing unit 103 sends, to the storage medium control unit 104, a command to read an encryption key for encrypting the read data of the normal area 123, which is stored in the authentication area 124. The storage medium control unit 104 controls the normal resource 110 to send, to the storage medium 121, the command to read the encryption key from the authentication area 124 (S20).

After confirming that the command received by the data sending/receiving control device 122 is a command to read encryption key data from the authentication area 124, the storage medium 121 reads the encryption key from the authentication area 124 and sends the encryption key to the normal resource 110 via the data bus 128 (S20).

The normal resource 110 sends the received encryption key to the storage medium control unit 104, and the storage medium control unit 104 sends the received encryption key to the storage medium processing unit 103 (S20).

The storage medium processing unit 103 sends the encryption key received from the storage medium control unit 104 to the encryption control unit 105 (S20).

The encryption control unit 105 sets the received encryption key for the secure resource 109, and notifies a setting completion notification to the encryption control unit 105 (S20). The encryption control unit 105 notifies the setting completion notification to the storage medium processing unit 103 (S20).

The storage medium processing unit 103 which has received the setting completion notification from the encryption control unit 105 sends the encrypted contents 126 which have been read to the encryption control unit 105 and notifies a command to decrypt the data to the encryption control unit 105 (S22).

When the received command is a command to decrypt the data, and an encryption key corresponding to the encrypted contents 126 received in advance is set for the secure resource 109, the encryption control unit 105 sends the received encrypted contents 126 and the command to decrypt the data to the secure resource 109 (S22).

When the received command is a command to decrypt the data, the secure resource 109 decrypts the received encrypted contents 126 with the previously set encryption key corresponding to the encrypted data of the normal area 123 (S22).

When the decryption completes and succeeds, the secure resource 109 sends the decrypted encrypted contents 126 to the encryption control unit 105, and the encryption control unit 105 sends them to the storage medium processing unit 103 (S22). When the decryption fails, the secure resource 109 sends the decryption failure result to the encryption control unit 105, and the encryption control unit 105 sends it to the storage medium processing unit 103 (S22).

When receiving the decryption failure result from the encryption control unit 105 (S24: NO), the storage medium processing unit 103 proceeds to an abnormality processing.

When receiving the decrypted encrypted contents 126 from the encryption control unit 105 (S24: YES), the storage medium processing unit 103 proceeds to S26.

When the data of the normal area 123 read at S12 is unencrypted plain text contents 125 (S18: NO), the storage medium processing unit 103 proceeds to S26.

The storage medium processing unit 103 performs various processings for the plain text contents 125 read at S12, the decrypted encrypted contents 126, and the data of the normal area 123 (S26). After completion of the processings, the storage medium processing unit 103 proceeds to S28.

When there is any other data of the normal area 123 to be processed (S28: YES), the storage medium processing unit 103 proceeds to S10.

When there is not any other data of the normal area 123 to be processed (S28: NO), the storage medium processing unit 103 proceeds to normal end.

When the command received from the normal mode switching control unit 107 is a command to access the authentication area 124 of the storage medium 121 (S8: NO; S30: YES), the secure mode switching control unit 102 sends, to the storage medium processing unit 103, a command to request the access to the authentication area 124 (S32).

After confirming that the received command is a command to access the authentication area 124, the storage medium processing unit 103 sends, to the storage medium control unit 104, a command to acquire data for performing the mutual authentication with the storage medium 121 (S34).

After confirming that the received command is a command to acquire the data for the mutual authentication, the storage medium control unit 104 controls the normal resource 110 to send the data-for-mutual-authentication acquisition command to the storage medium 121 via the data bus 128 (S34).

When the received command is a data-for-mutual-authentication acquisition command, the storage medium 121 sends the result of the data-for-mutual-authentication acquisition command (the data for the mutual authentication acquired on the basis of the data-for-mutual-authentication acquisition command) to the normal resource 110.

The normal resource 110 receives the result of the data-for-mutual-authentication acquisition command from the storage medium 121 (S36). Furthermore, the normal resource 110 notifies the result of the data-for-mutual-authentication acquisition command received from the storage medium 121 to the storage medium control unit 104, and the storage medium control unit 104 notifies the received result to the storage medium processing unit 103 (S36).

When the received result of the data-for-mutual-authentication acquisition command indicates abnormality (S38: NO), the storage medium processing unit 103 proceeds to the abnormality processing.

When the received result of the data-for-mutual-authentication acquisition command indicates normality (S38: YES), the storage medium processing unit 103 sends, to the encryption control unit 105, a part of the received result of the data-for-mutual-authentication acquisition command required for mutual authentication or all of the received result of the data-for-mutual-authentication acquisition command together with a mutual authentication command (S40).

After confirming that the received command is a mutual authentication command, the encryption control unit 105 sends a part or all of the received data for mutual authentication and the mutual authentication command to the secure resource 109 (S40).

After confirming that the secure resource 109 has received the mutual authentication command and a part or all of the data for mutual authentication, it executes a mutual authentication processing and returns the result of the mutual authentication processing to the encryption control unit 105 (S42).

The encryption control unit 105 notifies the result of the mutual authentication processing to the storage medium processing unit 103. When the received result of the mutual authentication processing indicates abnormality (S44; NO), the storage medium processing unit 103 proceeds to the abnormality processing.

When the received result of the mutual authentication processing indicates normality (S44: YES), the storage medium processing unit 103 sends, to the storage medium control unit 104, a command to request access to the authentication area 124. After confirming that the received command is a command to access the authentication area 124, the storage medium control unit 104 controls the normal resource 110 of the data sending/receiving control device 108 to send, to the storage medium 121 via the data bus 128, the command to access the authentication area 124 (S46).

The storage medium 121 receives the access command sent from the normal resource 110 by the data sending/receiving control device 122. After confirming that the received access command is a command to access the authentication area 124, the storage medium 121 accesses the authentication area 124 and sends the access result to the normal resource 110 via the data sending/receiving control device 122 and the data bus 128.

The normal resource 110 receives the access result from the data sending/receiving control device 122 (S48). The normal resource 110 which has received the access result notifies the storage medium control unit 104 that the access to the authentication area 124 has completed and that it has received the access result (S50).

The storage medium control unit 104 judges whether the access result indicates success or failure. When the result of accessing the authentication area 124, which has been received from the normal resource 110, indicates success (S52: YES), the processing proceeds to S54. When the result of accessing the authentication area 124, which has been received from the normal resource 110, indicates failure (S52: NO), the storage medium control apparatus 100 abnormally ends.

When the data of the authentication area 124 read at S48 is encrypted (S54: YES), the storage medium processing unit 103 sends the read data of the authentication area 124 to the encryption control unit 105 and requests a decryption processing (S56).

The encryption control unit 105 sends the received data of the authentication area 124 to the secure resource 109 and controls the secure resource 109 to decrypt the received data of the authentication area 124 (S56).

The encryption control unit 105 controls the secure resource 109 to send the decrypted data of the authentication area 124 to the storage medium processing unit 103 (S56). The encryption control unit 105 controls the secure resource 109 to send a decryption failure result to the storage medium processing unit 103 when the decryption of the data of the authentication area 124 fails (S56).

When receiving the decrypted data of the authentication area 124 (S58: YES), the storage medium processing unit 103 proceeds to S60.

When receiving the decryption failure result from the encryption control unit 105 (S58: NO), the storage medium processing unit 103 proceeds to the abnormality processing.

When the data of the authentication area 124 read at S48 is the unencrypted plain text contents 125 (S54: NO), the storage medium processing unit 103 proceeds to S60.

The storage medium processing unit 103 performs various processings for the plain text contents 125 read at S48, the decrypted encrypted contents 126, and the data of the authentication area 124 (S60). After completion of the processings, the storage medium processing unit 103 proceeds to S62.

When there is any other data of the authentication area 124 to be processed (S62: YES), the storage medium processing unit 103 proceeds to S46.

When there is not any other data of the authentication area 124 to be processed (S62: NO), the storage medium processing unit 103 proceeds to the normal end.

As described above, according to the present embodiment, it is possible to directly access the normal resource 110 from the secure mode unit 101 even in the secure mode. Therefore, it is not necessary to perform the switching to the normal mode when accessing the data stored in the storage medium 121 in the secure mode. Accordingly, it is possible to reduce the number of times of switching between the secure mode and the normal mode. Furthermore, it is possible to perform the processing without the normal mode unit 106 handling the copyright protection information (the right information). Accordingly, it is possible to improve the processing performance while protecting the copyright protection information (the right information) in the security mode.

### Second Embodiment

A storage medium control system according to a second embodiment of the present invention will be described with reference to drawings.

An aspect of utilization of the storage medium control system is similar to what is shown in FIG. 1. The aspect of utilization of the storage medium control system according to a third embodiment and subsequent embodiments is also similar.

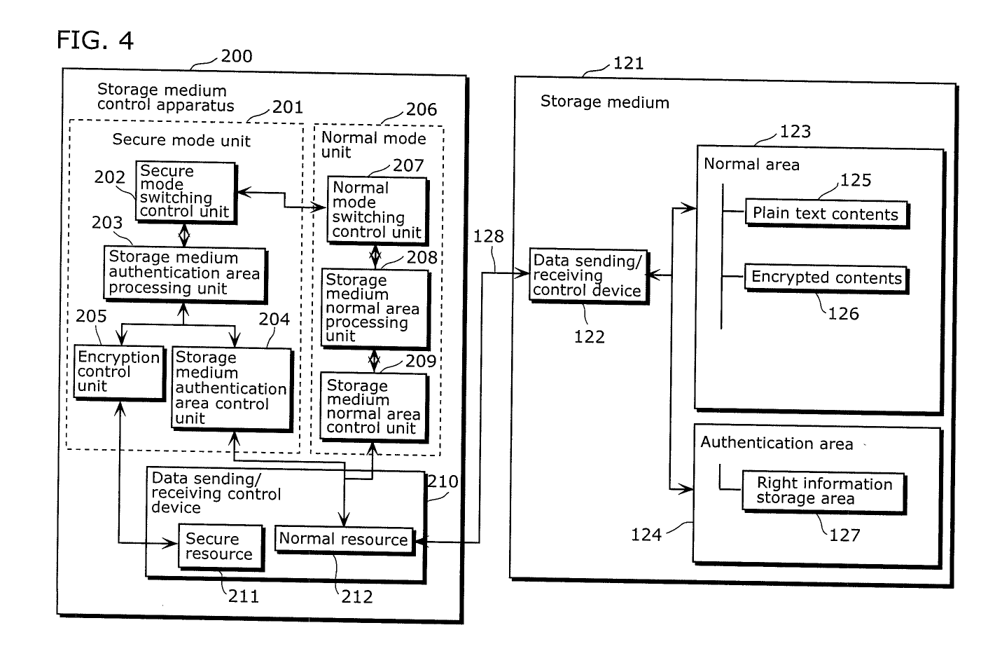

FIG. 4 is a functional block diagram showing a configuration of a storage medium control system 20 according to the second embodiment.

The storage medium control system 20 is provided with a storage medium 121 and a storage medium control apparatus 200.

The storage medium 121 is similar to what is shown in the first embodiment. Therefore, a detailed description thereof is not repeated here.

As for the storage medium control apparatus 200, a description will be made mainly on differing points from the storage medium control apparatus 100 according to the first embodiment shown in FIG. 2.

The storage medium control apparatus 200 is an apparatus which reads and writes data to and from the storage medium 121, and it is provided with a normal mode unit 206, a secure mode unit 201, and a data sending/receiving control device 210.

The storage medium control apparatus 200 is provided with a common CPU, a memory, and the like, and it realizes the normal mode unit 206 and the secure mode unit 201 described above by executing programs stored in the memory.

The data sending/receiving control device 210 is configured by hardware.

Note that, since other components are not directly related to the present invention, they are neither illustrated nor described.

The secure mode unit 201 is provided with a secure mode switching control unit 202, a storage medium authentication area processing unit 203, a storage medium authentication area control unit 204, and an encryption control unit 205.

The normal mode unit 206 is provided with a normal mode switching control unit 207, a storage medium normal area processing unit 208, and a storage medium normal area control unit 209.

The data sending/receiving control device 210 is provided with a secure resource 211 and a normal resource 212.

The storage medium normal area control unit 209 and the storage medium authentication area control unit 204 correspond to the storage medium control unit 104 in the storage medium control apparatus 100, and they are software modules which control, via the normal resource 212, reading and writing of data to and from the normal area 123 and the authentication area 124 inside the storage medium 121, and also control the encryption control unit 205.

The storage medium normal area control unit 209 is a software module which accesses only the normal area 123 of the storage medium 121 via the normal resource 212.

The storage medium authentication area control unit 204 is a software module which accesses only the authentication area 124 of the storage medium 121 via the normal resource 212 and the secure resource 211.

The storage medium normal area processing unit 208 and the storage medium authentication area processing unit 203 correspond to the storage medium processing unit 103 in the storage medium control apparatus 100, and they are software modules which perform access to the storage medium 121, mutual authentication between the storage medium 121 and the storage medium control apparatus 200, and encryption and decryption of contents data, via the storage medium normal area processing unit 208, the storage medium authentication area control unit 204, and the encryption control unit 205.

The storage medium normal area processing unit 208 is a software module which performs a processing of data of the normal area 123 of the storage medium 121 via the storage medium normal area control unit 209.

The storage medium authentication area processing unit 203 is a software module which performs a processing of the data of the authentication area 124 of the storage medium 121 via the storage medium authentication area control unit 204.

That is, what differs from the first embodiment is that the storage medium normal area control unit 209 and the storage medium normal area processing unit 208 exist in the normal mode unit 206, and the storage medium authentication area control unit 204 and the storage medium authentication area processing unit 203 exist in the secure mode unit 201.

Other configuration requirements, that is, the secure mode switching control unit 202, the encryption control unit 205, the normal mode switching control unit 207, the data sending/receiving control device 210, the secure resource 211, and the normal resource 212 respectively correspond to the secure mode switching control unit 102, the encryption control unit 105, the normal mode switching control unit 107, the data sending/receiving control device 108, the secure resource 109, and the normal resource 110 shown in FIG. 2.

Next, a control processing for the storage medium 121 performed by both the secure mode unit 201 and the normal mode unit 206 will be described.

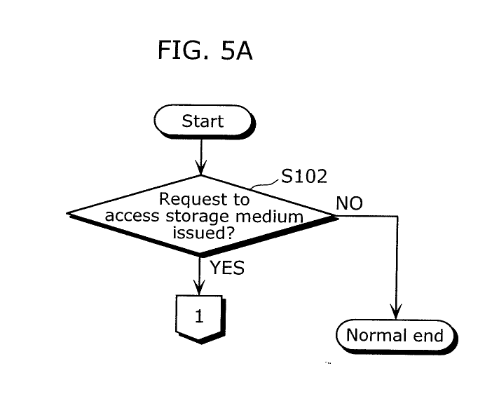

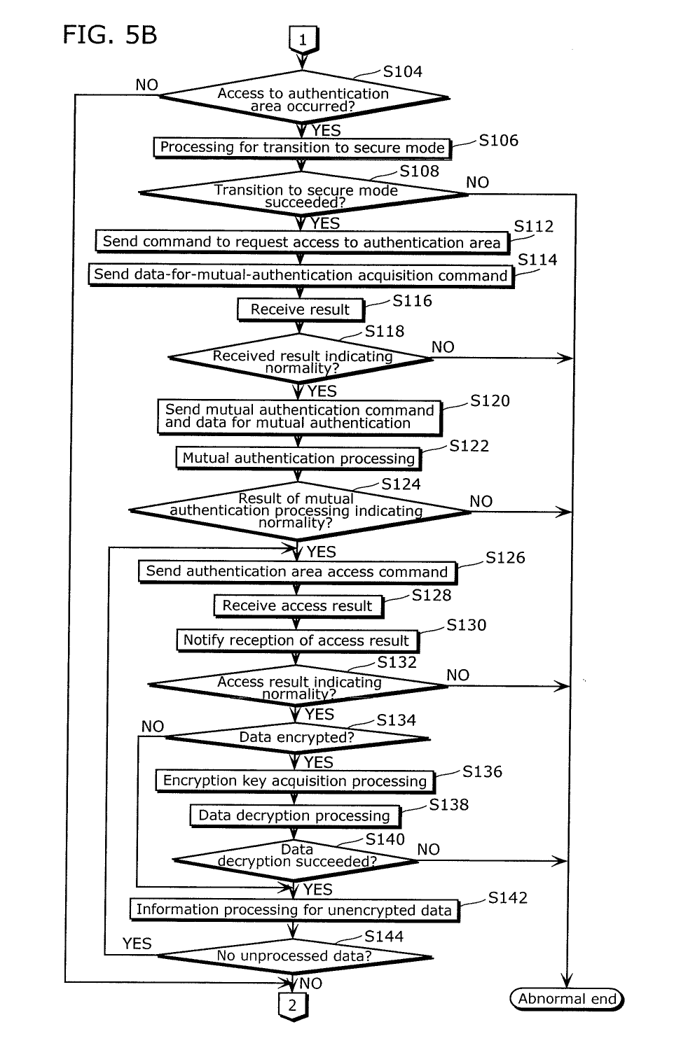

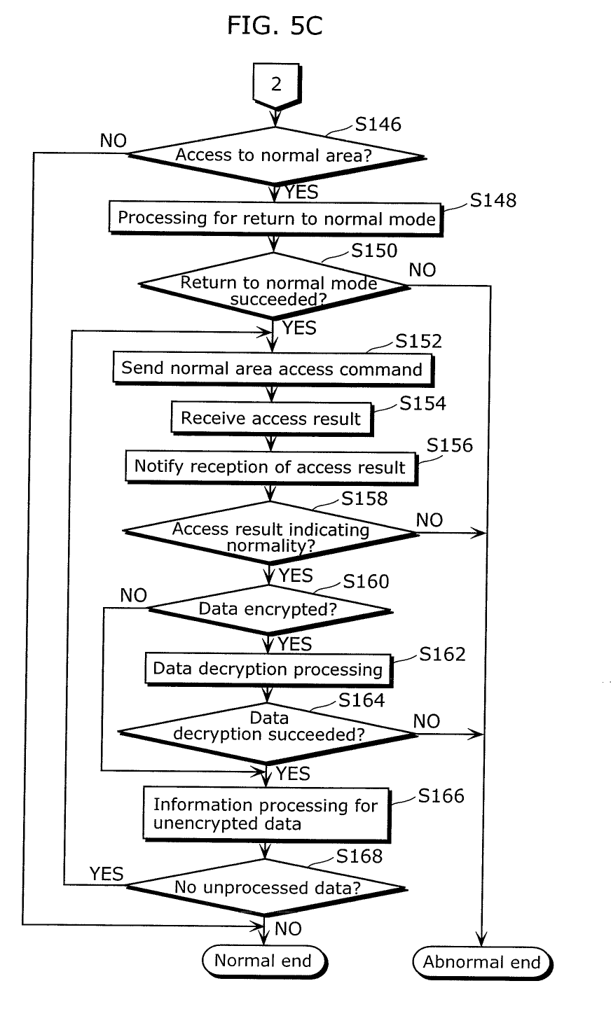

FIGS. 5A to 5C are flowcharts showing the control processing for the storage medium 121 performed by both the secure mode unit 201 and the normal mode unit 206. What differs from the first embodiment is that a processing load in the secure mode is reduced by performing only a processing for accessing the authentication area 124 of the storage medium 121, an encryption processing, and a decryption processing in the secure mode.

As the scenes where it is assumed that the above processing is performed, various scenes are assumed, such as a case of inserting the memory card 11 into the mobile phone 10 to reproduce encrypted contents recorded in the memory card 11 and a case of inserting the memory card 11 into the mobile phone 10 to record the encrypted contents in the memory card 11. Note that the timing of performing the above processing depends on the storage medium control apparatus 100 such as the mobile phone 10, and the processing may be performed at any timing.

When a request to access the storage medium 121 is issued by the storage medium control apparatus 200 (S102: YES), and it can be confirmed that access to the authentication area of the storage medium 121 has occurred (S104: YES), the normal mode switching control unit 207 sends a command to the secure mode switching control unit 202 to switch from the normal mode to the secure mode (S106). When the request to access the authentication area of the storage medium 121 has not been issued (S104: NO), the processing proceeds to S148.

When the secure mode switching control unit 202 receives the command from the normal mode switching control unit 207, it is assumed that the transition from the normal mode to the secure mode has succeeded (S108: YES). When the secure mode switching control unit 202 of the secure mode unit 201 cannot receive the command from the normal mode switching control unit 207 of the normal mode unit 206, it is assumed that the transition to the secure mode has failed (S108: NO), and the storage medium control apparatus 200 abnormally ends.

The secure mode switching control unit 202 performs processing on the basis of the command received from the normal mode switching control unit 207. However, when the received command is a command to access the authentication area 124 of the storage medium 121, the secure mode switching control unit 202 sends, to the storage medium authentication area processing unit 203, a command to request the access to the authentication area 124 (S112).

After confirming that the received command is a command to access the authentication area 124, the storage medium authentication area processing unit 203 sends, to the storage medium authentication area control unit 204, a command to acquire data for performing the mutual authentication with the storage medium 121 (S114).

After confirming that the received command is a data-for-mutual-authentication acquisition command, the storage medium authentication area control unit 204 controls the normal resource 212 to send the data-for-mutual-authentication acquisition command to the storage medium 121 via the data bus 128 (S114).

When the received command is a data-for-mutual-authentication acquisition command, the storage medium 121 sends the result of the data-for-mutual-authentication acquisition command to the normal resource 212.

The normal resource 212 notifies the result of the data-for-mutual-authentication acquisition command received from the storage medium 121 to the storage medium authentication area control unit 204 (S116), and the storage medium authentication area control unit 204 notifies it to the storage medium authentication area processing unit 203 (S116).

When the received result of the data-for-mutual-authentication acquisition command indicates abnormality (S118: NO), the storage medium authentication area processing unit 203 proceeds to an abnormality processing.

When the result of the received data-for-mutual-authentication acquisition command indicates normality (S118: YES), the storage medium authentication area processing unit 203 sends, to the encryption control unit 205, a part of the received result of the data-for-mutual-authentication acquisition command required for mutual authentication or all of the received result of the data-for-mutual-authentication acquisition command together with the mutual authentication command (S120).

After confirming that the received command is a mutual authentication command, the encryption control unit 205 sends a part or all of the received data for mutual authentication and the mutual authentication command to the secure resource 211 (S120).

After confirming that the secure resource 211 has received the mutual authentication command and a part or all of the data for mutual authentication, it executes a mutual authentication processing and returns the result of the mutual authentication processing to the encryption control unit 205 (S122).

The encryption control unit 205 notifies the result of the mutual authentication processing to the storage medium authentication area processing unit 203. When the received result of the mutual authentication processing indicates abnormality (S124: NO), the storage medium authentication area processing unit 203 proceeds to the abnormality processing.

When the received result of the mutual authentication processing indicates normality (S124: YES), the storage medium authentication area processing unit 203 sends, to the storage medium authentication area control unit 204, a command to request access to the authentication area 124 (S126). After confirming that the received command is a command to access the authentication area 124, the storage medium authentication area control unit 204 controls the normal resource 212 of the data sending/receiving control device 210 to send, to the storage medium 121 via the data bus 128, a command to access the authentication area 124 (S126).

The storage medium 121 receives the access command sent from the normal resource 212 by the data sending/receiving control device 122. After confirming that the received access command is a command to access the authentication area 124, the storage medium 121 accesses the authentication area 124 and sends the access result to the normal resource 212 via the data sending/receiving control device 122 and the data bus 128 (S128).

The normal resource 212 which has received the access result from the normal resource 212 notifies the storage medium authentication area control unit 204 that the access to the authentication area 124 has completed and that it has received the access result (S130).

When the result of the access to the authentication area 124 received from the normal resource 212 indicates success (S132: YES), the storage medium authentication area control unit 204 proceeds to S134. When the result of the access to the authentication area 124 received from the normal resource 212 indicates failure (S132: NO), the storage medium control apparatus 200 abnormally ends.

When the data of the authentication area 124 read at S128 is encrypted (S134: YES), the storage medium authentication area processing unit 203 sends, to the storage medium authentication area control unit 204, a command to read an encryption key stored in the authentication area 124 (S136).

The storage medium authentication area control unit 204 controls the normal resource 212 to send, to the storage medium 121, the command to read an encryption key from the authentication area 124 (S136).

After confirming that the command received by the data sending/receiving control device 122 is a command to read encryption key data from the authentication area 124, the storage medium 121 reads the encryption key from the authentication area 124 and sends the encryption key to the normal resource 212 via the data bus 128 (S136).

The normal resource 212 sends the received encryption key to the storage medium authentication area control unit 204, and the storage medium authentication area control unit 204 sends the received encryption key to the storage medium authentication area processing unit 203 (S136).

The storage medium authentication area processing unit 203 sends the encryption key received from the storage medium authentication area control unit 204 to the encryption control unit 205 (S136).

The encryption control unit 205 sets the received encryption key for the secure resource 211, and notifies a setting completion notification to the encryption control unit 205. The encryption control unit 205 notifies the setting completion notification to the storage medium authentication area processing unit 203 (S136).

The storage medium authentication area processing unit 203 sends the read data of the authentication area 124 to the encryption control unit 205 and requests the decryption processing (S138).

The encryption control unit 205 sends the received data of the authentication area 124 to the secure resource 211, and controls the secure resource 211 to decrypt the received data of the authentication area 124 (S138).

The encryption control unit 205 controls the secure resource 211 to send the decrypted data of the authentication area 124 to the storage medium authentication area processing unit 203 (S138). The encryption control unit 205 controls the secure resource 211 to send a decryption failure result to the storage medium authentication area processing unit 203 when the decryption of the data of the authentication area 124 failed (S140: NO).

When receiving the decryption failure result from the encryption control unit 205 (S140: NO), the storage medium authentication area processing unit 203 proceeds to the abnormality processing.

When receiving the decrypted data of the authentication area 124 (S140: YES), the storage medium authentication area processing unit 203 proceeds to S142.

The storage medium authentication area processing unit 203 performs various processings for the read plain text contents 125, the decrypted encrypted contents 126, and the data of the authentication area 124 (S142).

When there is any other data of the authentication area 124 to be processed (S144: YES), the storage medium authentication area processing unit 203 proceeds to S10.

When there is not any other data of the authentication area 124 to be processed (S144: NO), the storage medium authentication area processing unit 203 proceeds to S146.

When the normal area 123 of the storage medium 121 is not accessed (S146: NO), the storage medium control apparatus 200 normally ends.

When the normal area 123 of the storage medium 121 is accessed (S146: YES), the secure mode switching control unit 202 sends a command to the normal mode switching control unit 207 to switch to the normal mode (S148). When the normal mode switching control unit 207 receives the command from the secure mode switching control unit 202, a return from the secure mode unit 201 to the normal mode unit 206 is successful (S150: YES).

When the normal mode switching control unit 207 cannot receive the command from the secure mode switching control unit 202, it is assumed that the return to the normal mode failed (S150: NO), and the storage medium control apparatus 200 abnormally ends.

After confirming that the received command is a command to access the normal area 123, the storage medium normal area processing unit 208 sends, to the storage medium normal area control unit 209, a command to request the access to the normal area 123 (S152). After confirming that the received command is a command to access the normal area 123, the storage medium normal area control unit 209 controls the normal resource 212 of the data sending/receiving control device 210 to send, to the storage medium 121 via a data bus 128, a command to access the normal area 123 (S152).

The storage medium 121 receives the access command sent from the normal resource 212 by the data sending/receiving control device 122. After confirming that the received access command is a command to access the normal area 123, the storage medium 121 accesses the normal area 123 and sends the access result to the normal resource 212 via the data sending/receiving control device 122 and the data bus 128.

The normal resource 212 receives the access result from the data sending/receiving control device 122 (S154). The normal resource 212 which has received the access result notifies the storage medium normal area control unit 209 that the access to the normal area 123 has completed and it has received the access result (S156).

When the result of the access to the normal area 123 received by the storage medium control unit 209 from the normal resource 212 indicates success (S158: YES), the processing proceeds to S160. When the result of the access to the normal area 123 received from the normal resource 212 indicates failure (S158: NO), the storage medium control apparatus 200 abnormally ends.

When the decryption processing of the encrypted contents 126 stored in the normal area is performed by the storage medium normal area processing unit 208, and an encryption key corresponding to the encrypted contents 126 is set for the secure resource 211 in advance in the secure mode (S160: YES), the received encrypted contents 126 and a command to decrypt the data are sent to the normal resource 212 (S162).

When the received command is a command to decrypt the data, the normal resource 212 decrypts the received encrypted contents 126 with the encryption key corresponding to the encrypted data of the normal area 123, which has been set in advance, via the secure resource 211 (S162). However, though the decryption processing is actually performed by the secure resource 211, the processing for setting for the secure resource 211 is not performed. Therefore, it is possible to perform the processing by the normal mode unit 206.

After the decryption is successfully completed, the normal resource 212 sends the decrypted encrypted contents 126 to the storage medium normal area control unit 209, and the storage medium normal area control unit 209 sends them to the storage medium normal area processing unit 208 (S162). When the decryption fails, the normal resource 212 sends the decryption failure result to the storage medium normal area control unit 209, and the storage medium normal area control unit 209 sends the received decryption failure result to the storage medium normal area processing unit 208 (S162).

When receiving the decryption failure result from the storage medium normal area control unit 209 (S164: NO), the storage medium normal area processing unit 208 proceeds to the abnormality processing.

When receiving the decrypted encrypted contents 126 from the storage medium normal area control unit 209 (S164: YES), the storage medium normal area processing unit 208 proceeds to S166.

The storage medium authentication area processing unit 203 performs various processings for the read plain text contents 125, the decrypted encrypted contents 126, and the data of the normal area 123 (S166).

When there is any other data of the normal area 123 to be processed (S168: YES), the storage medium normal area processing unit 208 proceeds to S152.

When there is not any other data of the normal area 123 to be processed (S168: NO), the storage medium normal area processing unit 208 proceeds to normal end.

As described above, according to the present embodiment, it is possible to directly access the normal resource 212 from the secure mode unit 201, similarly to the first embodiment. Therefore, it is not necessary to perform the switching to the normal mode when accessing the data stored in the storage medium 121 in the secure mode. Accordingly, it is possible to reduce the number of times of switching between the secure mode and the normal mode.

Furthermore, it is possible to easily add the secure mode unit 201 and the data sending/receiving control device 210 while avoiding a modification of the software modules of the normal mode unit 206 configured by an existing general-purpose OS as much as possible. Therefore, it is possible to easily add a function of accessing the authentication area 124 of the storage medium 121 to an existing storage medium control system which accesses the normal area 123 of the storage medium 121.

### Third Embodiment

A storage medium control system according to a third embodiment of the present invention will be described with reference to drawings.

A configuration of the storage medium control system according to the third embodiment is similar to that of the storage medium control system according to the second embodiment shown in FIG. 4. Therefore, a detailed description thereof is not repeated here.

Next, a control processing for a storage medium 121 performed by both a secure mode unit 201 and a normal mode unit 206 will be described.

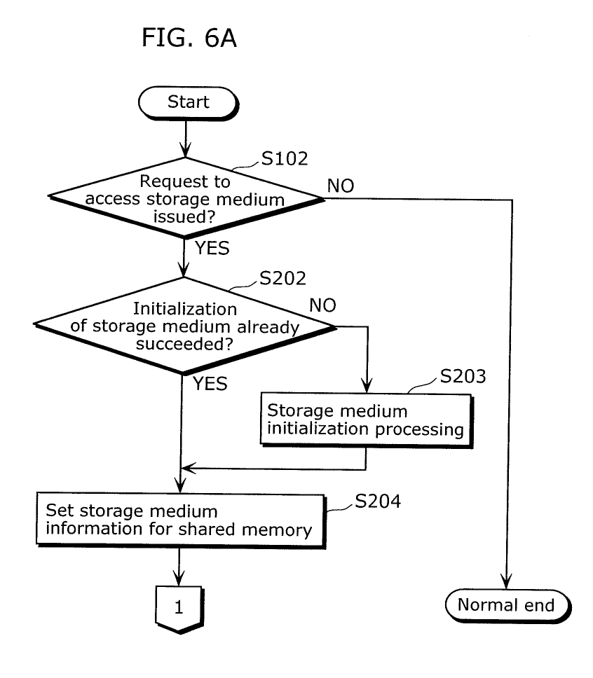

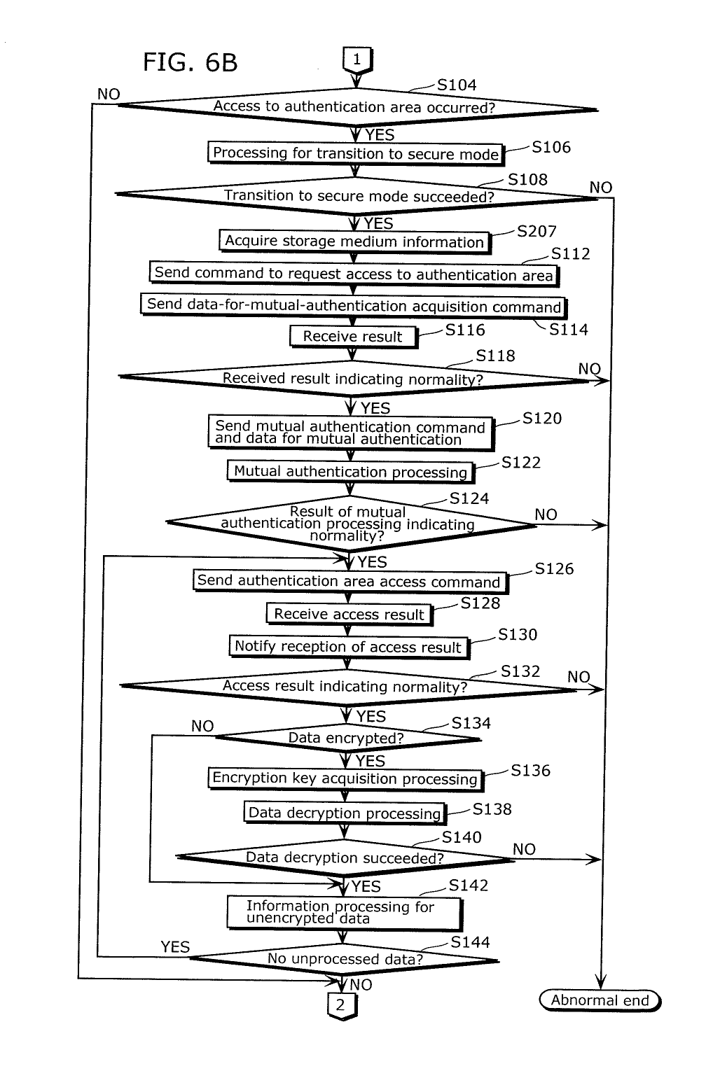

FIGS. 6A, 6B and 5C are flowcharts showing the control processing for the storage medium 121 performed by both the secure mode unit 201 and the normal mode unit 206.

Though the basic processing is similar to that of the second embodiment, a storage medium authentication area control unit 204 acquires storage medium information to be described later, in order to keep the consistency between access to an authentication area 124 from the secure mode unit 201 and access to an normal area 123 from the normal mode unit 206. The present embodiment also differs from the second embodiment in that the storage medium 121 is accessed on the basis of the storage medium information.

Hereinafter, a description will be made mainly on the different processings.

In the present embodiment, it is assumed that a shared memory (not shown) which is shared by the secure mode unit 201 and the normal mode unit 206 is provided in the storage medium control apparatus 200. The storage medium information acquired by the storage medium authentication area control unit 204 is stored in the shared memory and shared by the secure mode unit 201 and the normal mode unit 206.

With reference to FIG. 6A, when a request to access the storage medium 121 is issued by a storage medium control apparatus 200 (S102: YES), a storage medium normal area processing unit 208 confirms whether an initialization processing of the storage medium 121 has succeeded (S202) before it is confirmed at S104 to be executed later whether access to the authentication area 124 of the storage medium 121 has occurred.

When the initialization processing has not succeeded (S202: NO), the storage medium normal area processing unit 208 sends a request to initialize the storage medium 121 to a storage medium normal area control unit 209. On the basis of the initialization request, the storage medium normal area control unit 209 acquires “storage medium information” such as address information, area size, and access size about the storage medium 121, notifies the information to the storage medium normal area processing unit 208 (S203), and proceeds to S204.

When the initialization processing has already succeeded (S202: YES) or after S203 is executed, the acquired storage medium information is stored at a particular address of the shared memory which can be commonly accessed by the normal mode unit 206 and the secure mode unit 201 (S204).

With reference to FIG. 6B, when access to the authentication area 124 of the storage medium 121 occurs after that (S104: YES) and success of transition to the secure mode is confirmed (S108: YES), the storage medium authentication area control unit 204 acquires the storage medium information from the shared memory on the basis of the address information about the shared memory handed from the storage medium authentication area processing unit 203, and internally holds the storage medium information (S207). After that, the storage medium information held by the storage medium authentication area control unit 204 is used when data is sent to or received from the storage medium 121.

As described above, according to the present embodiment, the storage medium information is designed to be stored in the shared memory which can be accessed by both the secure mode unit 201 and the normal mode unit 206, in addition to the advantages of the embodiments described above. Therefore, the initialization processing for a storage medium may be performed only in any one of the normal mode and the secure mode.

### (First Modification)

In the storage medium control system according to the third embodiment, the storage medium authentication area control unit 204 of the secure mode unit 201 may independently acquire the storage medium information without using the shared memory.

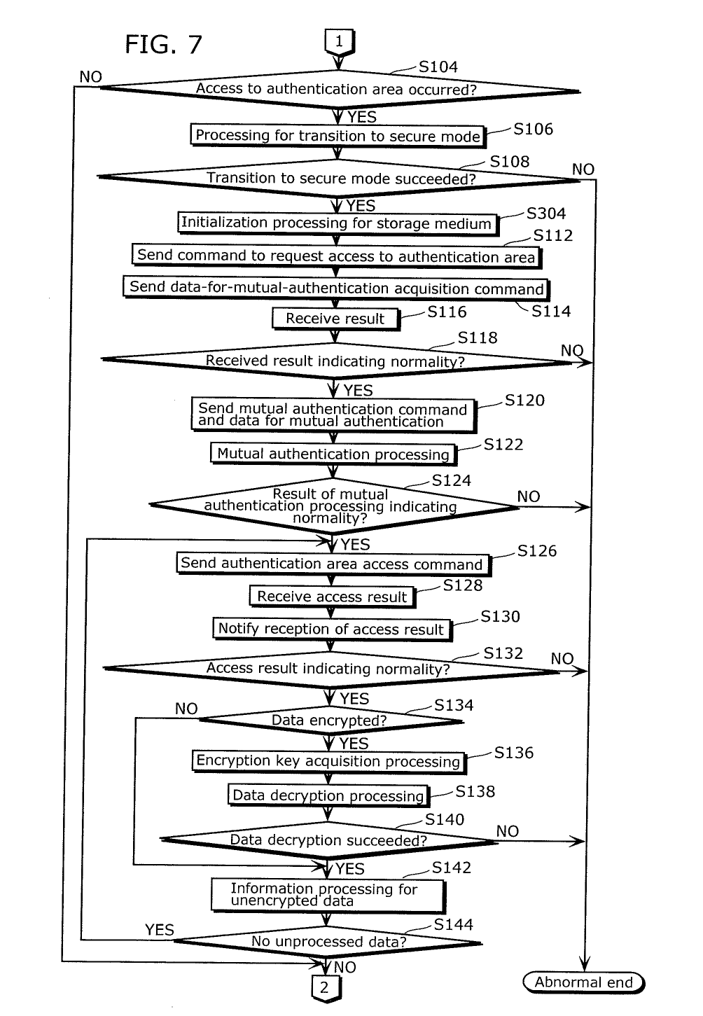

That is, the storage medium control system according to the third embodiment may perform the processings shown in FIGS. 5A, 7 and 5C instead of the processings shown in FIGS. 6A, 6B and 5C.

With reference to FIG. 7, when success of transition to the secure mode is confirmed at S108 (S108: YES), the storage medium authentication area control unit 204 initializes the storage medium 121, acquires and holds the storage medium information, on the basis of an instruction from the storage medium authentication area processing unit 203 (S304), irrespective of whether or not the storage medium 121 has been initialized. After that, the storage medium information held by the storage medium authentication area control unit 204 is used when data is sent to or received from the storage medium 121.

According to a first modification, the storage medium authentication area control unit 204 can acquire the storage medium information independently from the storage medium normal area control unit 209. Therefore, the operation is possible without synchronizing the storage medium normal area control unit 209 and the storage medium authentication area control unit 204, so that the processing can be speeded up.

### (Second Modification)

In the storage medium control system according to the third embodiment, the storage medium information may be encrypted and handed from the normal mode unit 206 to the secure mode unit 201 using the shared memory.

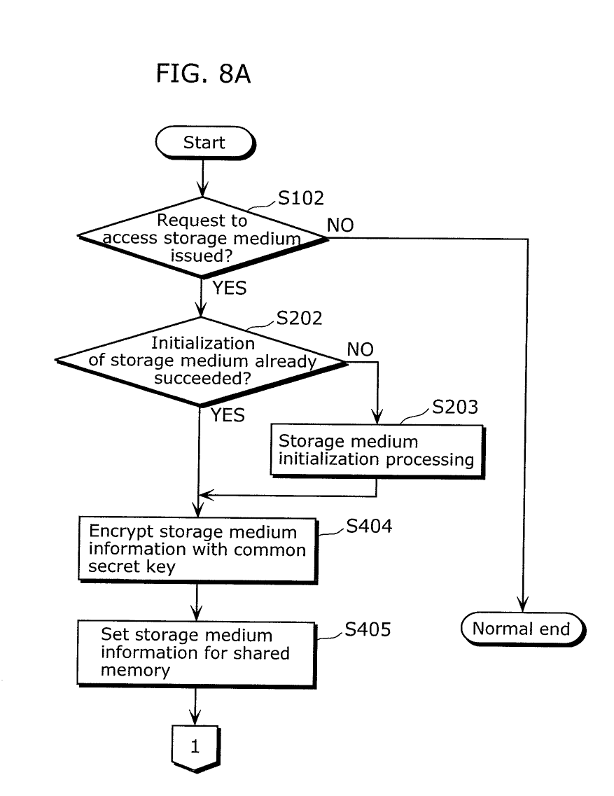

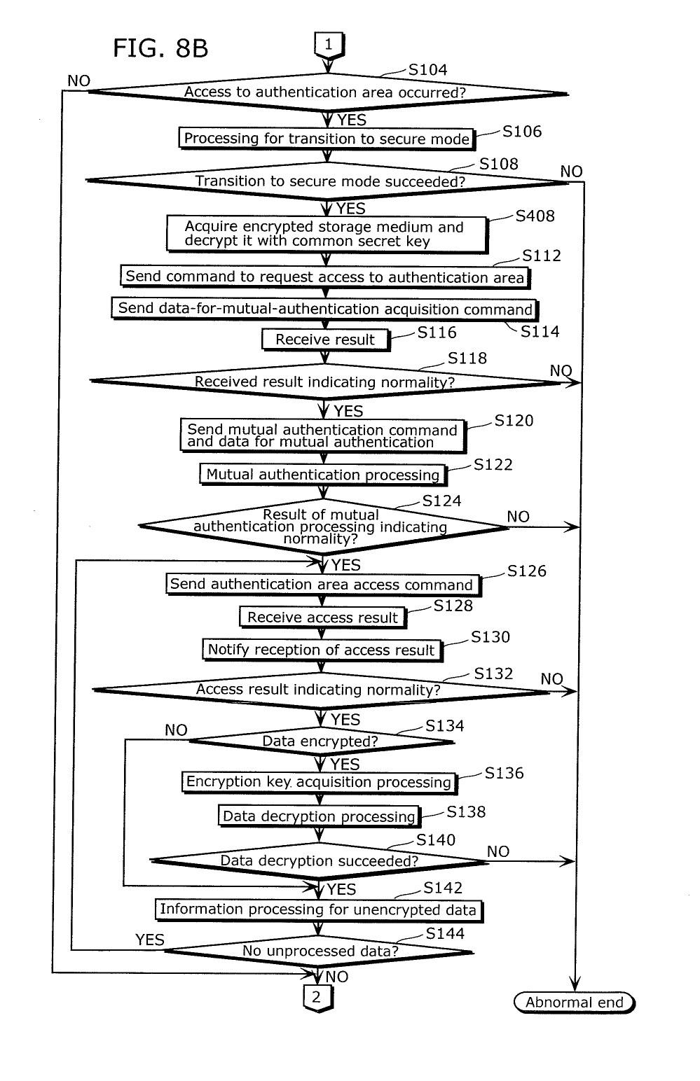

That is, the storage medium control system according to the third embodiment may execute the processings shown in FIGS. 8A, 8B and 5C instead of the processings shown in FIGS. 6A, 6B and 5C.

First, it is assumed that a common secret key used for cryptography is shared by the storage medium normal area processing unit 208 and the storage medium authentication area processing unit 203.

With reference to FIG. 8A, when a request to access the storage medium 121 is issued by the storage medium control apparatus 200 (S102: YES), the storage medium normal area processing unit 208 confirms whether the initialization processing of the storage medium 121 has succeeded (S202) before it is confirmed at S104 to be executed later whether access to the authentication area 124 of the storage medium 121 has occurred.

When the initialization processing has not succeeded (S202: NO), the storage medium normal area processing unit 208 issues a request to initialize the storage medium 121 to the storage medium normal area control unit 209. On the basis of the initialization request, the storage medium normal area control unit 209 acquires “storage medium information” such as the address information, the area size, and the access size about the storage medium 121, notifies the information to the storage medium normal area processing unit 208 (S203), and proceeds to S404.

When the initialization processing has already succeeded (S202: YES) or after S203 is executed, an encryption processing is performed for the acquired storage medium information using the common secret key in accordance with a particular algorithm to generate encrypted storage medium information (S404).

The encrypted storage medium information is stored at a particular address of the shared memory which can be commonly accessed by the normal mode unit 206 and the secure mode unit 201 (S405).

With reference to FIG. 8B, when access to the authentication area 124 of the storage medium 121 occurs after that (S104: YES), and success of transition to the secure mode is confirmed (S108: YES), the storage medium authentication area control unit 204 acquires the encrypted storage medium information set at S405 from the shared memory, on the basis of the address information about the shared memory handed from the storage medium authentication area processing unit 203, and internally holds the storage medium information after setting the common secrete key for the encryption control unit 205 and decrypting the encrypted storage medium information (S408). After that, the storage medium information held by the storage medium authentication area control unit 204 is used when data is sent to or received from the storage medium 121.

According to a second modification, by encrypting data when the data is sent and received between the storage medium normal area control unit 209 and the storage medium authentication area control unit 204, it is possible to improve the strength of security of data in sending/receiving of the data.

### Fourth Embodiment

A storage medium control system according to a fourth embodiment of the present invention will be described with reference to drawings.

A configuration of the storage medium control system according to the fourth embodiment is similar to that of the storage medium control system according to the second embodiment shown in FIG. 4. Therefore, a detailed description thereof is not repeated here.

Next, a method for controlling a storage medium 121 by both a secure mode unit 201 and a normal mode unit 206 will be described.

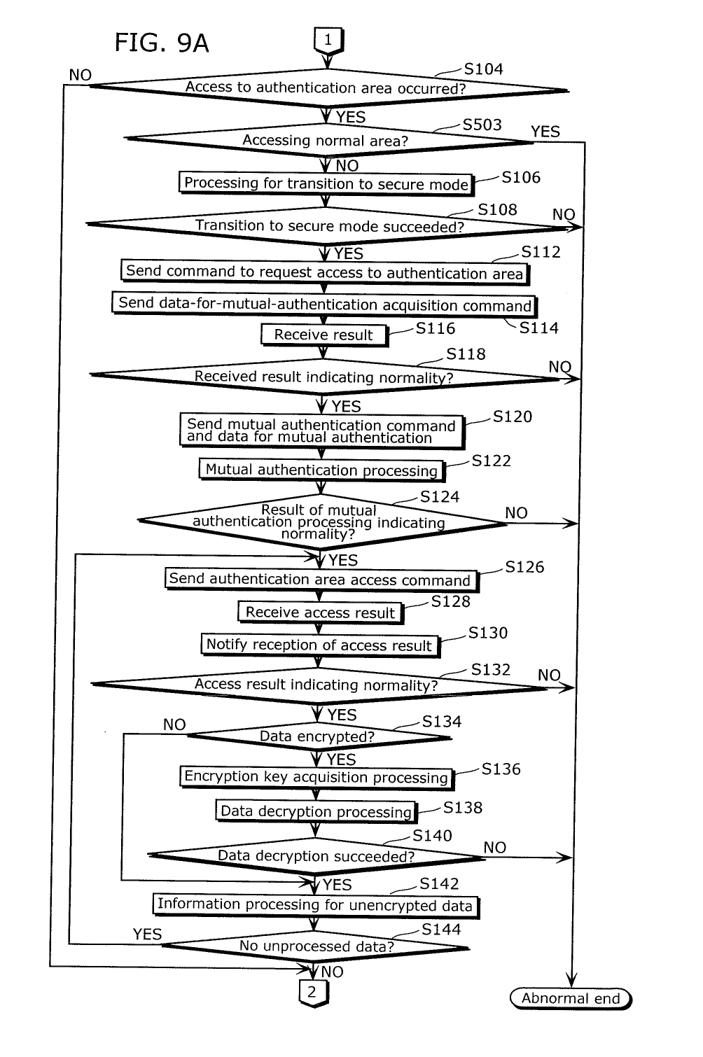

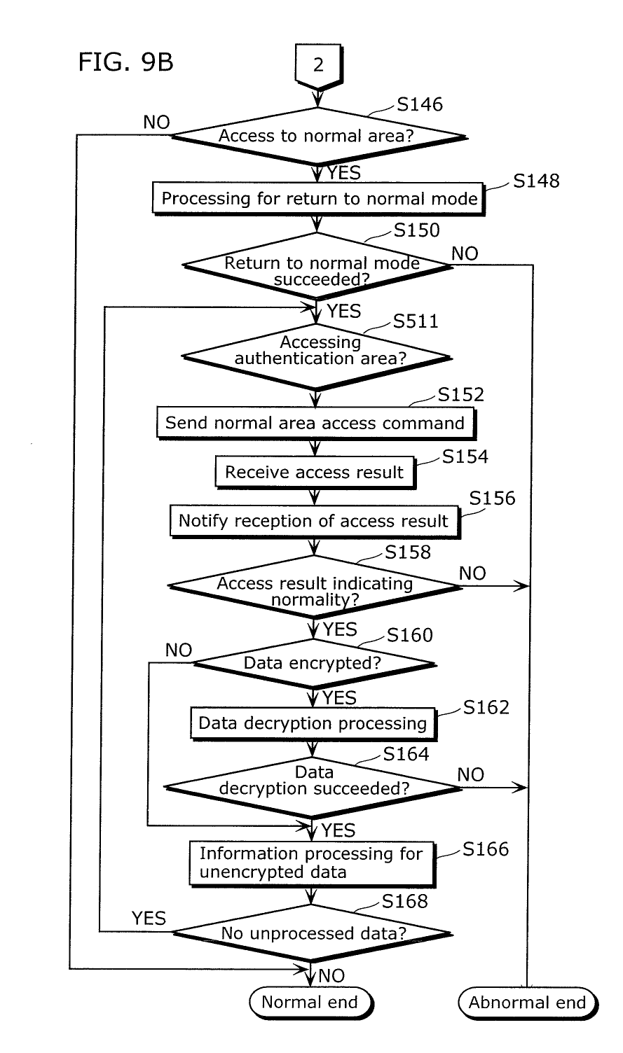

FIGS. 5A, 9A and 9B are flowcharts showing a control processing of the storage medium 121 from both of the secure mode unit 201 and the normal mode unit 206.

Though a basic processing is similar to that of the second embodiment, the present embodiment differs from the second embodiment in that it includes a processing for confirming which area is being accessed so as to avoid a conflict between access to the authentication area 124 of the storage medium 121 and access to the normal area 123 of the storage medium 121, in order to keep the consistency between access to the authentication area 124 from the secure mode unit 201 and access to the normal area 123 from the normal mode unit 206.

Hereinafter, a description will be made below mainly on the different processes.

Since the processing in FIG. 5A is as described above, a description thereof is not repeated.

With reference to FIG. 9A, when a request to access the storage medium 121 is issued by the storage medium control apparatus 200, and it is confirmed that a request to access the authentication area 124 of the storage medium 121 has been issued (S104: YES), the storage medium normal area processing unit 208 confirms whether or not the storage medium normal area control unit 209 accesses the normal area 123 of the storage medium 121 (S503). When it is judged that the normal area 123 is not accessed (S503: NO), a flow proceeds to S106 to transition to the secure mode.

When it is judged that the normal area 123 is accessed (S503: YES), the storage medium control apparatus 200 abnormally ends at once. Alternatively, there is no problem that, instead of the abnormal end, the storage medium control apparatus 200 keep the processing waiting for a predetermined time to wait until the access to the normal area 123 ends, and then the flow proceeds to S106 to transition to the secure mode.

On the contrary, with reference to FIG. 9B, when it is confirmed that a request to access the normal area 123 of the storage medium 121 has been issued (S146: YES), the storage medium authentication area processing unit 203 confirms whether the storage medium authentication area control unit 204 accesses the authentication area 124 of the storage medium 121 (S511). When it is judged that the authentication area 124 is not accessed (S511: NO), the flow proceeds to S152 to access the storage medium 121, and send and receive data.

When it is judged that the authentication area 124 is accessed (S511: YES), the storage medium control apparatus 200 abnormally ends at once. Alternatively, there is no problem that, instead of the abnormal end, the storage medium control apparatus 200 keeps the processing waiting for a predetermined time to wait until the access to the authentication area 124 ends, and then the flow proceeds to S152.

As described above, according to the fourth embodiment, it is possible to perform exclusive control so that the storage medium normal area control unit 209 and the storage medium authentication area control unit 204 do not access the storage medium 121 at the same time, in addition to the operation and advantages of the embodiments described above.

### (Modification)

In the storage medium control system according to the fourth embodiment, it is also possible to hold a state of access to a storage medium in a shared memory (not shown) which can be accessed from both the secure mode unit 201 and the normal mode unit 206, and to perform the exclusive control on the basis of the access state so that the storage medium normal area control unit 209 and the storage medium authentication area control unit 204 do not access the storage medium 121 at the same time.

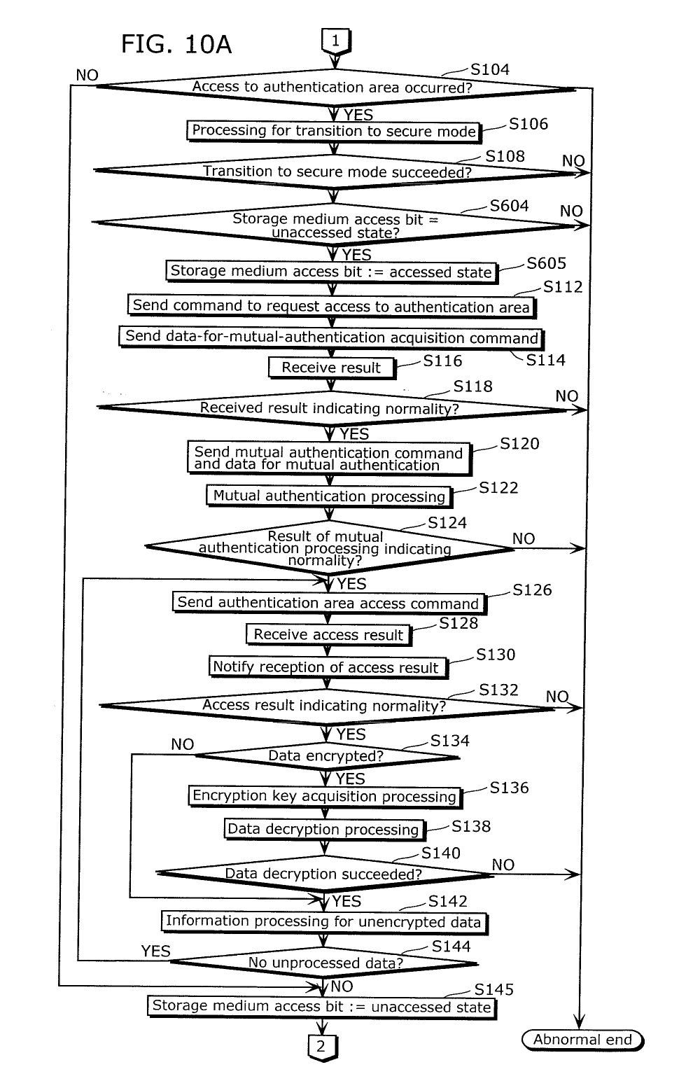

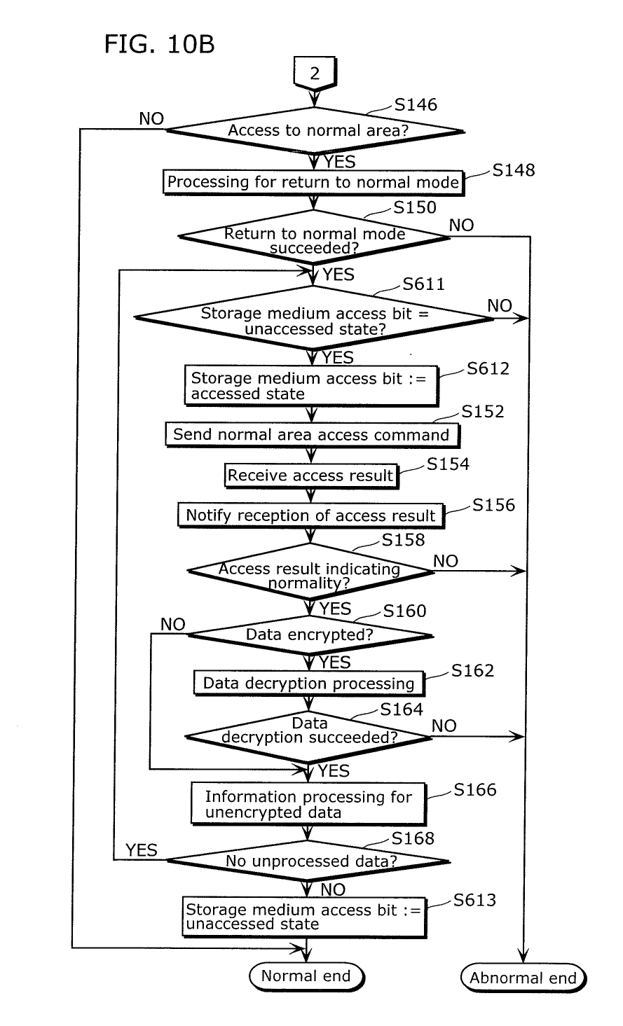

That is, the storage medium control system according to the fourth embodiment may perform the processings shown in FIGS. 5A, 10A and 10B instead of the processings shown in FIGS. 5A, 9A and 9B.

With reference to FIG. 10A, when a request to access the storage medium 121 is issued by the storage medium control apparatus 200 (S104: YES), and it is confirmed that a request to access the authentication area 124 of the storage medium 121 has been issued (S104: YES), the mode immediately transitions to the secure mode at S106.

When transition to the secure mode is normally executed (S108: YES), the storage medium authentication area control unit 204 confirms whether or not a bit indicating a condition of access to the storage medium 121, which is stored at a particular address in the shared memory (hereinafter referred to as a “storage medium access bit”) is set to “accessed state” (S604). When the bit indicating the state of access to the storage medium 121 is set to “unaccessed state” (S604: YES), the storage medium access bit is set to the “accessed state” (S605). Then, the flow proceeds to S112 where data is sent and received to and from the storage medium 121.

When the storage medium access bit is set to the “accessed state” in advance (S604: NO), the storage medium control apparatus 200 abnormally ends at once. Alternatively, there is no problem that, instead of the abnormal end, the storage medium control apparatus 200 keeps the processing waiting for a predetermined time to wait until the access to the storage medium 121 ends, and then the flow proceeds to S112 to send and receive the data to and from the storage medium 121.

After that, when it is judged that there is no processing data in the storage medium authentication area (S144: NO), the storage medium authentication area control unit 204 sets the storage medium access bit set at S604 to the “unaccessed state” (S145). Thereby, the access to the storage medium 121 is enabled.

On the contrary, with reference to FIG. 10B, when it is confirmed that a request to access the normal area 123 of the storage medium 121 has been issued (S146: YES), the storage medium normal area control unit 209 confirms whether or not the bit indicating the condition of access to the storage medium, which is stored at a particular address of the shared memory, is set to the “accessed state” (S611). When the storage medium access bit is set to the “unaccessed state” (S611: YES), the storage medium access bit is set to the “accessed state” (S612). Then, the flow proceeds to S152 to send and receive data to and from the storage medium 121.

When the storage medium access bit is set to the “accessed state” in advance (S611: NO), the storage medium control apparatus 200 abnormally ends at once. Alternatively, there is no problem that, instead of the abnormal end, the storage medium control apparatus 200 keeps the processing waiting for a predetermined time until the access to the storage medium 121 ends, and then the flow proceeds to S152 to send and receive data to and from the storage medium 121.

After that, when it is judged that there is no processing data in the normal area 123 of the storage medium 121 (S168: NO), the storage medium normal area control unit 209 sets the storage medium access bit set at S612 to the “unaccessed state” (S613). Thereby, the access to the storage medium 121 is enabled.

According to this modification, it is possible to perform the exclusive control so that the storage medium normal area control unit 209 and the storage medium authentication area control unit 204 do not access the storage medium 121 at the same time.

Furthermore, since the exclusive control is performed only by confirmation of a bit, the processing can be performed at a high speed.

### Fifth Embodiment

A storage medium control system according to a fifth embodiment of the present invention will be described with reference to drawings.

A configuration of the storage medium control system according to the fifth embodiment is similar to that of the storage medium control system according to the second embodiment shown in FIG. 5. Therefore, a detailed description thereof is not repeated here.

Next, a method for controlling a storage medium 121 by both a secure mode unit 201 and a normal mode unit 206 will be described.

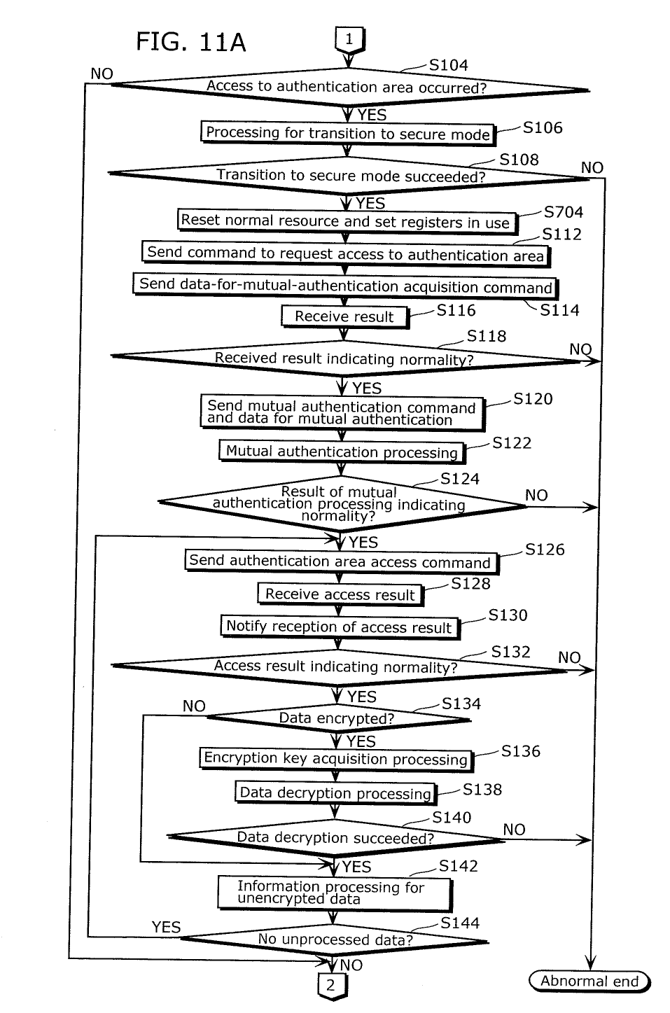

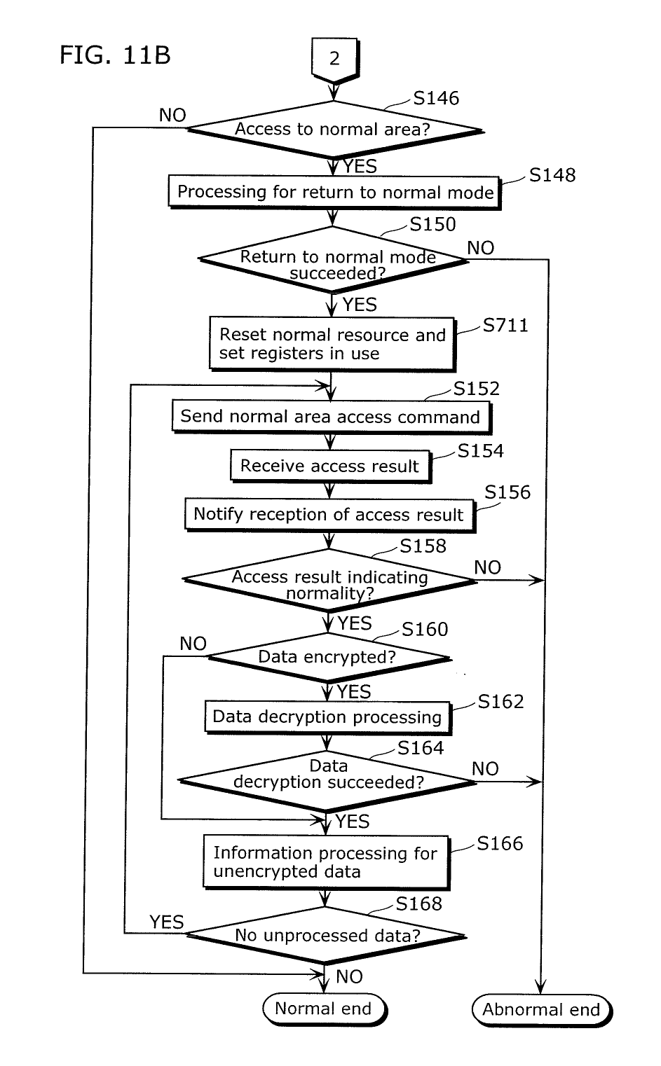

FIGS. 5A, 11A and 11B are flowcharts showing a control processing for the storage medium 121 performed by both the secure mode unit 201 and the normal mode unit 206.

Though a basic processing is similar to that of the second embodiment, the present embodiment differs from the second embodiment in that it includes a processing stage of preventing set values of a normal resource 212 set by a storage medium authentication area control unit 204 from being modified by a storage medium normal area control unit 209, and a processing stage of preventing the set values of the normal resource 212 set by the storage medium normal area control unit 209 from being modified by the normal resource 212, in order to keep the consistency between access to the authentication area 212 from the secure mode unit 201 and access to the normal area 209 from the normal mode unit 206. The “set values” refer to values about access bit width for accessing the storage medium 121, access size of data sent to or received from the storage medium 121, and the like.

Hereinafter, a description will be made mainly on different points. That is, there will be described a method for securing the independence of the set values by resetting the normal resource 212 and re-setting the register to be used each time the mode is switched.

Since the processing in FIG. 5A is as described above, a description thereof is not repeated.

With reference to FIG. 11A, when a request to access the storage medium 121 is issued by a storage medium control apparatus 200 (S104: YES), and it is confirmed that a request to access an authentication area 124 of the storage medium 121 has been issued (S104: YES), the mode immediately transitions to the secure mode (S106).

When a processing for transitioning to the secure mode is normally performed (S108: YES), the storage medium authentication area control unit 204 performs a reset processing of the normal resource 212 which accesses the storage medium 121 (S704). That is, the set values of the registers of the normal resource 212 set by the storage medium normal area control unit 209 in advance are cleared. Then, the storage medium authentication area control unit 204 sets the set values to be used to access the storage medium 121 for the registers of the normal resource 212 (S704). Then, the flow proceeds to S112 where data is sent and received to and from the storage medium 121 on the basis of the set values set for the registers of the normal resource 212.

On the contrary, with reference to FIG. 11B, when it is confirmed that a request to access the normal area 123 of the storage medium 121 has been issued (S146: YES), the storage medium normal area control unit 209 performs reset processing of the normal resource 212 which accesses the storage medium 121 (S711). Thereby, the set values set for the registers of the normal resource 212 by the storage medium normal area control unit 209 in advance are cleared. Then, the storage medium normal area control unit 209 sets the set values used to access the storage medium 121 for the registers of the normal resource 212 (S711). Then, the flow proceeds to S152 where data is sent and received to and from the storage medium 121 on the basis of the set values set for the registers of the normal resource 212.

As described above, according to the fifth embodiment, each of the storage medium normal area control unit 209 and the storage medium authentication area control unit 204 resets the registers of the normal resource 212 and sets the set values for the registers before accessing the storage medium 121, in addition to the operation and the advantages of the embodiments described above. Therefore, the storage medium authentication area control unit 204 can access the storage medium 121 without depending on the set values of the normal resource 212 set by the storage medium normal area control unit 209, and the storage medium normal area control unit 209 can access the storage medium 121 without depending on the set values of the normal resource 212 set by the storage medium authentication area control unit 204.

### (First Modification)

In the storage medium control system according to the fifth embodiment, independence of the set values of the normal mode and the secure mode may be secured by backing up the set values of the registers of the normal resource 212 used by the normal mode at the time of transition to the secure mode and restoring the backed-up set values on the registers at the time of exiting the secure mode.

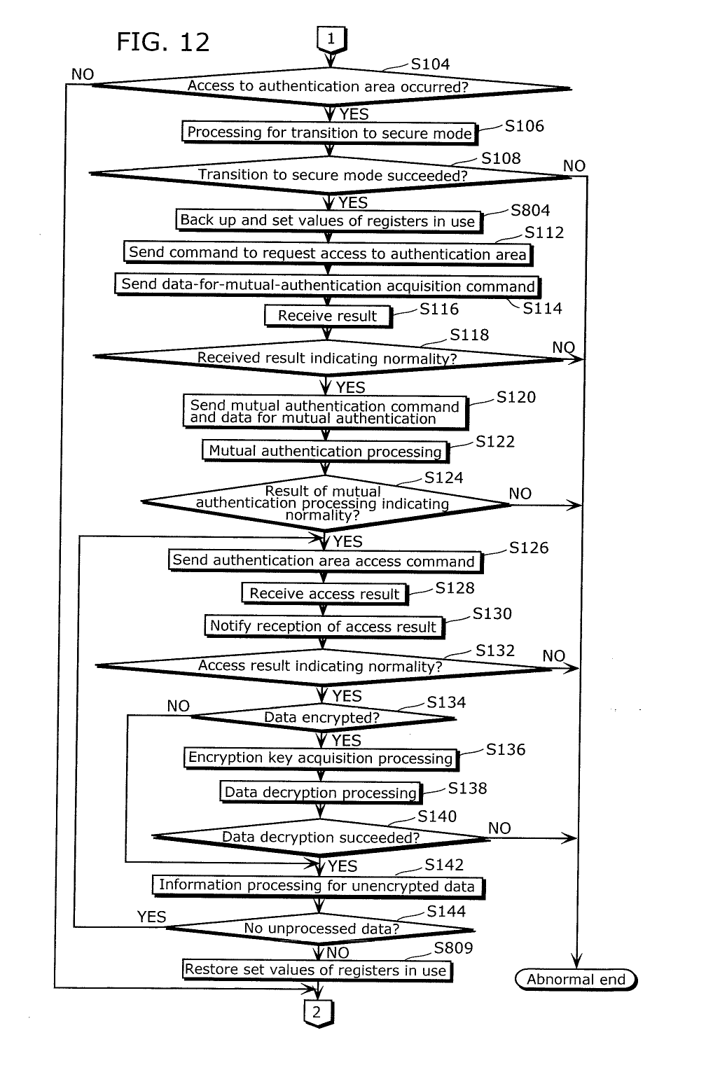

That is, the storage medium control system according to the fifth embodiment may perform the processings shown in FIGS. 5A, 12 and 5C instead of the processings shown in FIGS. 5A, 11A and 11B.

With reference to FIG. 12, when a request to access the storage medium 121 is issued by the storage medium control apparatus 200, and it is confirmed that a request to access the authentication area 124 of the storage medium 121 has been issued (S104: YES), the mode immediately transitions to the secure mode (S106).

When a transition to the secure mode is normally executed (S108: YES), the storage medium authentication area control unit 204 backs up, in a particular memory area, all the current set values of the registers for which the setting is to be changed, among the registers of the normal resource 212 which accesses the storage medium 121 (S804). Then, the storage medium authentication area control unit 204 sets the set values for the registers of the normal resource 212 to be used for access to the storage medium 121 (S804). Then, the flow proceeds to S112 where data is sent and received to and from the storage medium 121 on the basis of the set values set for the registers of the storage medium 121.

After that, when it is judged that there is not any other data to be processed that is stored in the authentication area 124 of the storage medium 121 (S144: YES), the storage medium authentication area control unit 204 reads the set values backed up in the particular memory area at S804 and re-sets the set values for the registers of the normal resource 212 used to access the storage medium 121 (S809).

According to the first modification, it is not necessary to modify an existing storage medium normal area control unit 209.

### (Second Modification)

In the storage medium control system according to the fifth embodiment, the normal resource may automatically switch the set values when the mode is switched.

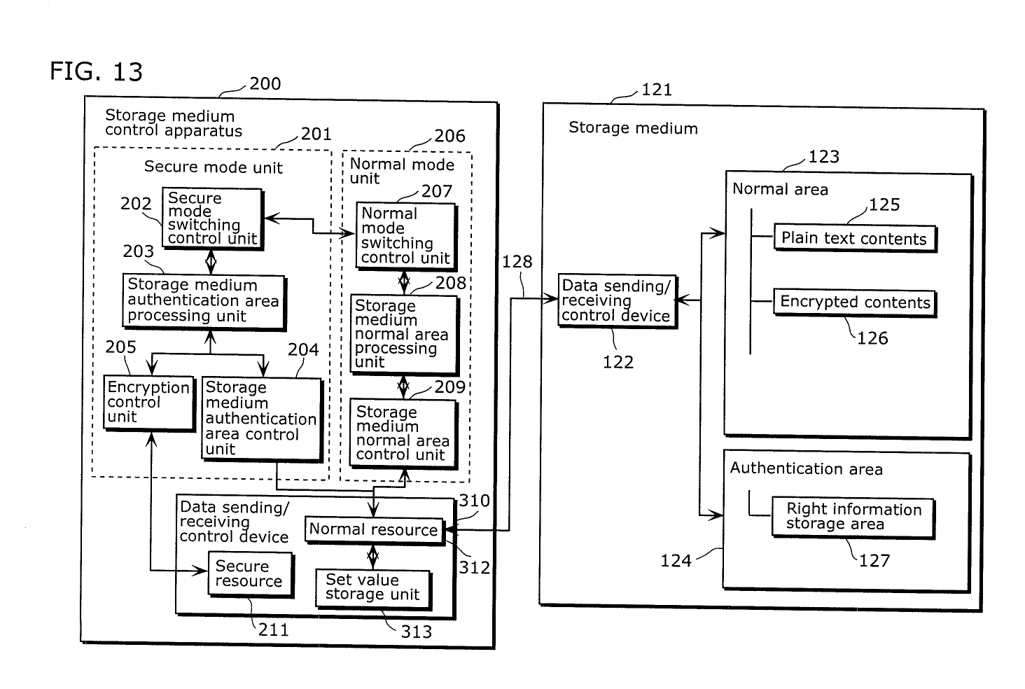

FIG. 13 is a functional block diagram showing a configuration of a storage medium control system according to the second modification.

The storage medium control system is provided with a storage medium control apparatus 300 and a storage medium 121.

The storage medium 121 is similar to what is shown in the first embodiment. Therefore, a detailed description thereof is not repeated here.

As for the storage medium control apparatus 300, a description will be made mainly on differing points from the storage medium control apparatus 200 shown in FIG. 4. That is, the storage medium control apparatus 300 uses a data sending/receiving control device 310 instead of the data sending/receiving control device 210 of the storage medium control apparatus 200. Other components are similar to those of the storage medium control apparatus 200.

The data sending/receiving control device 310 is provided with a secure resource 211, a normal resource 312, and a set value storage unit 313.

The set value storage unit 313 is a storage unit which stores set values to be used by the normal resource 312 to access the storage medium 121.

The normal resource 312 performs a processing similar to that of the normal resource 212. However, it is different in that it sets the set values stored in the set value storage unit 313 for its own registers when the mode is switched.

A method for controlling the storage medium 121 by the storage medium control apparatus 300 according to the second modification will be described below.

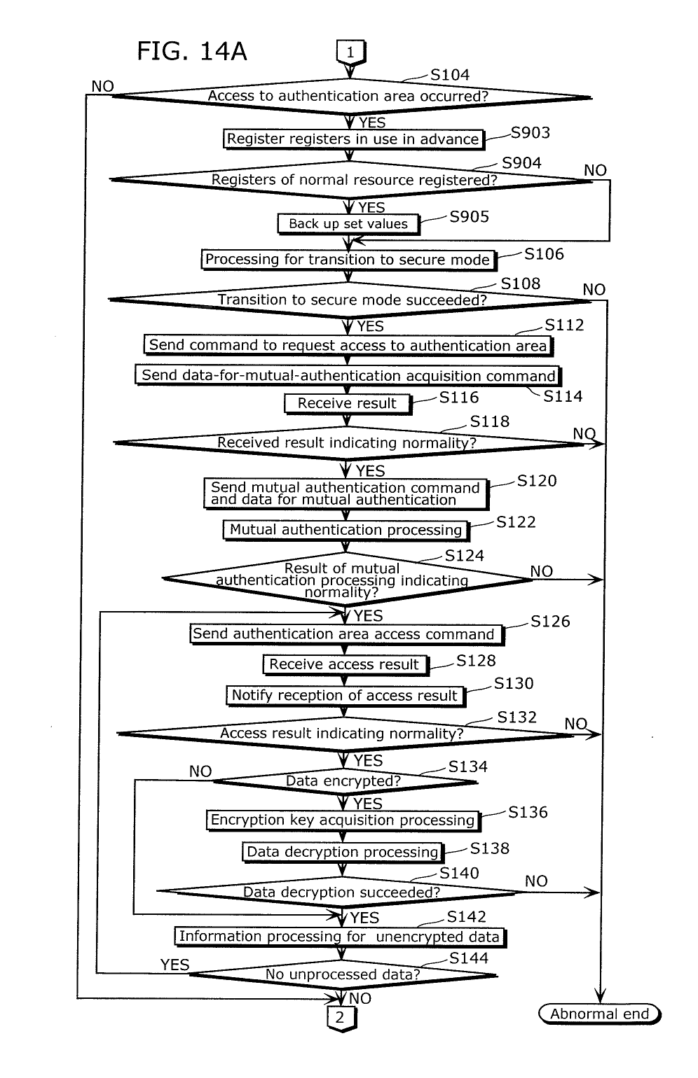

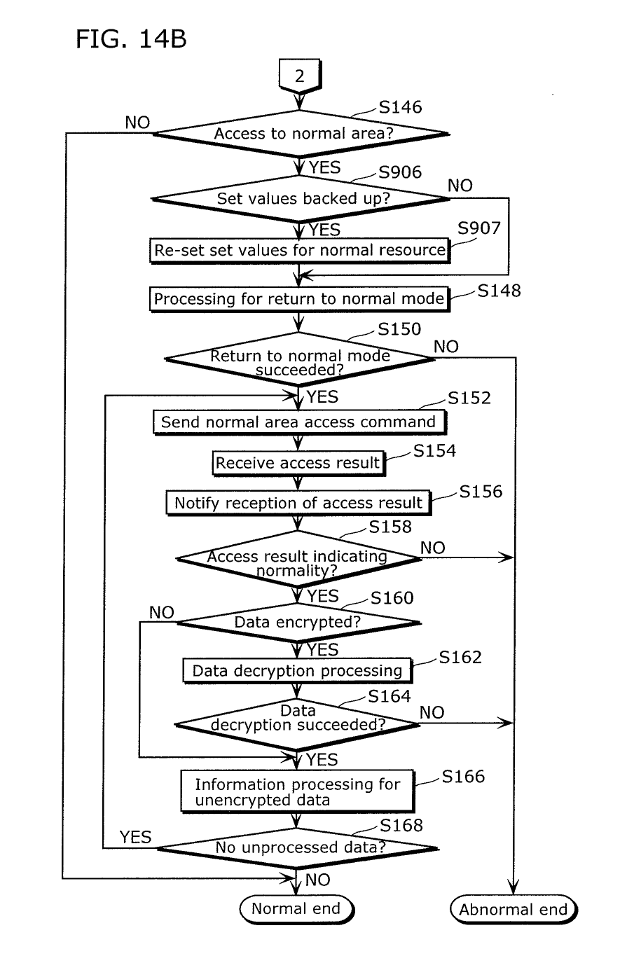

FIGS. 5A, 14A and 14B are flowcharts showing the control processing for the storage medium 121 performed by both the secure mode unit 201 and the normal mode unit 206.

Hereinafter, a description will be made below mainly on the different processings.

Since the processing in FIG. 5A is as described above, a description thereof is not repeated.

With reference to FIG. 14A, when a request to access the storage medium 121 is issued by the storage medium control apparatus 200, and it is confirmed that a request to access the authentication area 124 of the storage medium 121 has been issued (S104: YES), the storage medium authentication area control unit 204 registers the registers of the normal resource 312 to be used for access to the storage medium 121 with the set value storage unit 313 (S903).

When the registers of the normal resource 212 are registered with the set value storage unit 313 in transitioning to the secure mode at S106 (S904: YES), the normal resource 312 acquires the current set values of the registers from the normal resource 312, and backs up and stores them in the set value storage unit 313 (S905). When the registers of the normal resource 312 are not registered with the set value storage unit 313 (S904: NO), the normal resource 312 does not have to perform any processing.

With reference to FIG. 14B, when it is subsequently judged that there is not any other data to be processed that is stored in the authentication area 124 of the storage medium 121 (S144: NO), the following processing is performed in returning to the normal mode at S148. That is, when the current set values of the registers of the storage medium 121 are backed up in the set value storage unit 313 (S906: YES), the normal resource 312 re-sets the set values stored in the set value storage unit 313 for the normal resource 312 (S907). When no data is backed up in the set value storage unit 313 (S906: NO), the normal resource 312 does not have to perform any processing.

According to the second modification, the normal resource 312, which is hardware, performs backup and restoration of the set values when the mode is switched. Therefore, it is possible to make change in the set values accompanying switching of the mode, at a high speed.

### Sixth Embodiment

A storage medium control system according to a sixth embodiment of the present invention will be described with reference to drawings.

A configuration of the storage medium control system in the sixth embodiment is the same as that of the storage medium control system according to the second embodiment shown in FIG. 4. Therefore, a detailed description thereof is not repeated here.

Next, a method for controlling a storage medium 121 by both a secure mode unit 201 and a normal mode unit 206 will be described.

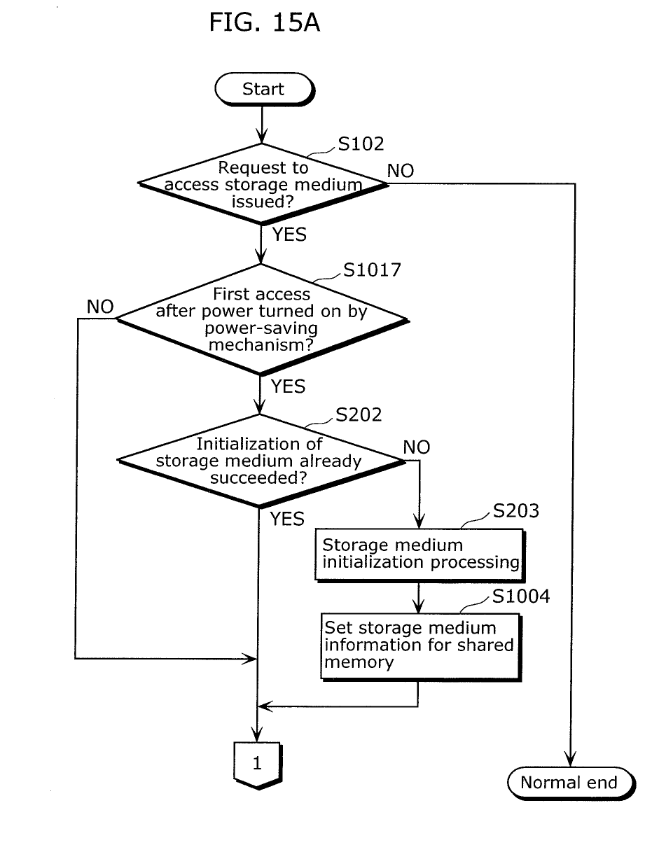

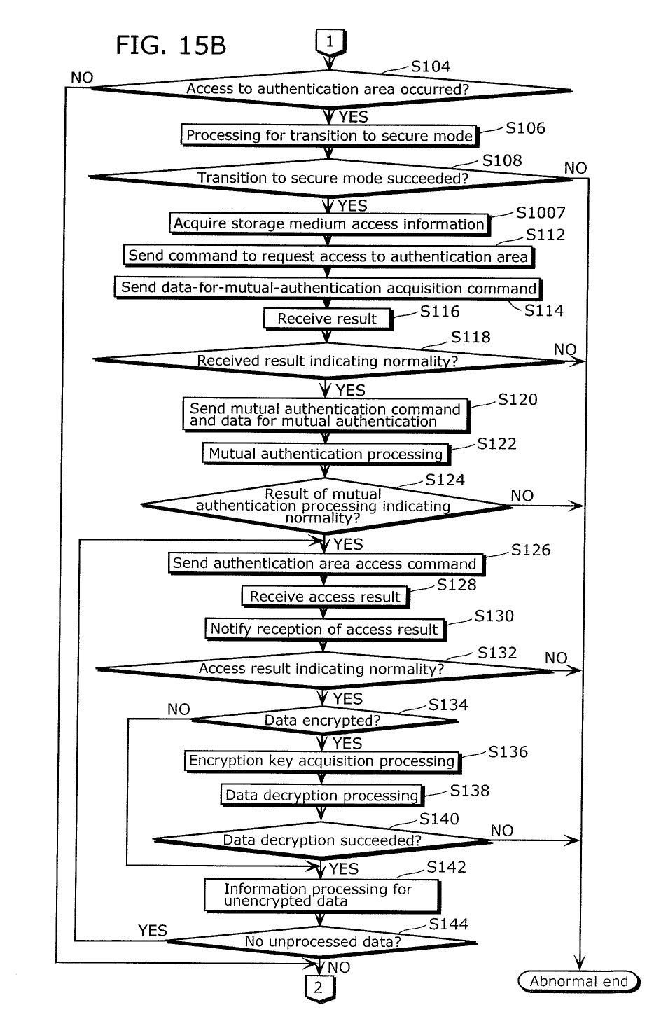

FIGS. 15A, 15B and 5C are flowcharts showing a control processing of the storage medium 121 performed by both the secure mode unit 201 and the normal mode unit 206.

Though a basic processing is similar to that of the second embodiment, the present embodiment differs from the second embodiment in that the processing can be speeded up while cooperation is performed between access to an authentication area 124 from the secure mode unit 201 and access to a normal area 123 from the normal mode unit 206.

Hereinafter, a description will be made mainly on different points.

Here, a storage medium control apparatus 200 the power to which is repeatedly turned on and off by a power-saving mechanism or the like is assumed here. Note that it does not matter if the storage medium control apparatus 200 is an apparatus by which a reset processing of a storage medium is performed, specifically such an apparatus that insertion/removal of a storage medium occurs or an apparatus which performs resetting in the case of occurrence of an abnormal state. Furthermore, it is assumed that, as a method for a storage medium authentication area control unit 204 to acquire the storage medium access information, only storage medium access information is handed from the normal mode unit 206 to the secure mode unit 201 via a shared memory. Thereby, the access to the authentication area 124 is speeded up. Note that the “storage medium access information” is identification information identifying the storage medium 121 among storage medium information.

With reference to FIG. 15A, when a request to access the storage medium 121 is issued by the storage medium control apparatus 200 (S102: YES), a storage medium normal area processing unit 208 confirms whether the access is the first access to the storage medium 121 after power is on, the power to the storage medium having been turned off by the power-saving mechanism of the storage medium control apparatus 200 (S1017). When the power has not been especially turned on or off (S1017: NO), a flow proceeds to S104 in FIG. 15B, and issuance of a request to access the authentication area 124 is confirmed as usual.

When it is confirmed that the access is the first access to the storage medium 121 after the power is on (S1017: YES), it is confirmed whether or not the storage medium 121 has been initialized (S202). When the storage medium 121 has been initialized (S202: YES), the flow proceeds to S104, and the issuance of a request to access the authentication is confirmed as usual. Note that, though the judgment criteria is whether the access is the first access after the power is on here, “after the power is on” means “after the storage medium is reset.” Similar processing is also possible after the storage medium is reset by insertion/removal thereof or occurrence of an abnormal state.

When the storage medium 121 has not been initialized (S202: NO), the storage medium normal area control unit 209 performs an initialization processing for the storage medium 121 (S203). Furthermore, in the case where any of the storage medium information has been notified to the storage medium authentication area control unit 204 via the shared memory at least once, it is not necessary to set all the storage medium information for the shared memory. Only such storage medium access information as may be changed by re-initialization of the storage medium 121 is set for the shared memory (S1004).

With reference to FIG. 15B, when it is confirmed that a request to access the authentication area 124 of the storage medium 121 is issued (S104: YES), the mode immediately transitions to the secure mode (S106).

When transition to the secure mode is normally executed (S108: YES), the storage medium authentication area control unit 204 acquires, from the shared memory, the storage medium access information for accessing the storage medium 121 which has been set at S1004 (S1007). Then, the flow proceeds to S112, and data is sent and received to and from the storage medium 121 using the storage medium access information.

As described above, according to the sixth embodiment, when the mode is switched, instead of notifying the storage medium information to the storage medium authentication area control unit 204, it is sufficient to notify only the storage medium access information, in addition to the operation and advantages of the embodiments described above. Thereby, the processing by the storage medium authentication area control unit 204 can be speeded up.

### (First Modification)

According to the storage medium control system of the sixth embodiment, it is also possible to speed up the access to the authentication area 124 by simplifying the mutual authentication process by the storage medium authentication area processing unit 203 in the storage medium control apparatus 200 where the power thereto is repeatedly turned on and off by a power-saving mechanism or the like.

That is, the storage medium control system according to the sixth embodiment may perform the processings shown in FIGS. 15A, 16A, 16B and 5C instead of the processings shown in FIGS. 15A, 15B and 5C.

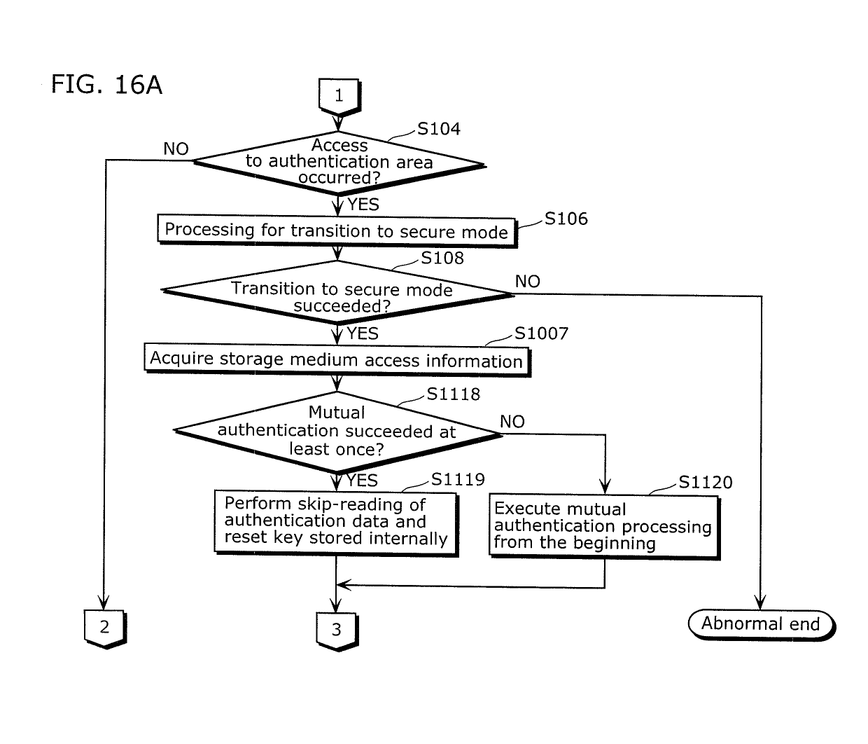

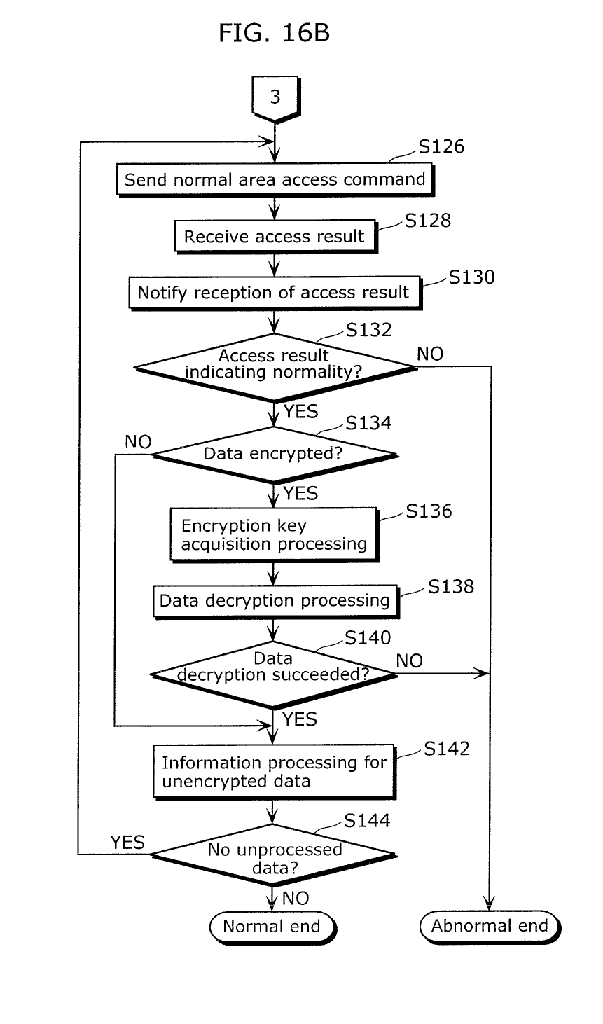

With reference to FIG. 16A, when it is confirmed by the storage medium authentication area processing unit 203 that mutual authentication has been succeeded at least once between the storage medium control apparatus 200 and the storage medium 121 after the storage medium access information is acquired at S1007 (S1118: YES), key information which has been already calculated is re-set for the secure resource, and skip-reading of authentication data from the storage medium 121 is performed once using the storage medium authentication area control unit 204 (S1119).

When the confirmation is not received (S1118: NO), the mutual authentication process is performed again between the storage medium control apparatus 200 and the storage medium 121.

Then, the flow proceeds to S126 shown in FIG. 16B, and the data is sent to or received from the storage medium 121.

According to the first modification, it is possible to omit the second and subsequent mutual authentication processings. Thereby, the processing can be speeded up.

### (Second Modification)

According to the storage medium control system of the sixth embodiment, it is also possible to speed up the access to the authentication area 124 by simplifying confirmation about whether or not the storage medium 121 has been initialized in the storage medium control apparatus 200 where the power thereto is repeatedly turned on and off by a power-saving mechanism or the like.

That is, the storage medium control system according to the sixth embodiment may perform the processings shown in FIGS. 17, 15B and 5C instead of the processings shown in FIGS. 15A, 15B and 5C.

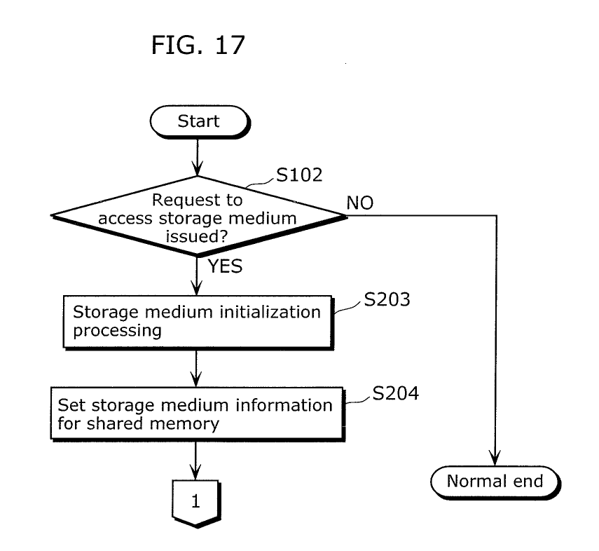

With reference to FIG. 17, when a request to access the storage medium 121 is issued by the storage medium control apparatus 200 (S102: YES), an initialization processing of the storage medium 121 is immediately performed (S203), irrespective of whether or not the access is the first access to the storage medium 121 after the power is on and whether or not the storage medium 121 has been initialized. Furthermore, only the storage medium access information which may be changed by re-initialization of the storage medium 121 is set for the shared memory (S204).

According to the second modification, the storage medium normal area control unit 209 can always start processing when the power is on, and on the other hand, the storage medium authentication area control unit 204 can always start processing on the assumption that the power is on. Therefore, the processing can be speeded up by reduction of the power on/off judgment processing.

### Seventh Embodiment

The storage medium control apparatuses according to the embodiments described above are applicable to various equipment. In a seventh embodiment, the storage medium control system is applied to a system for reproducing video and audio contents.

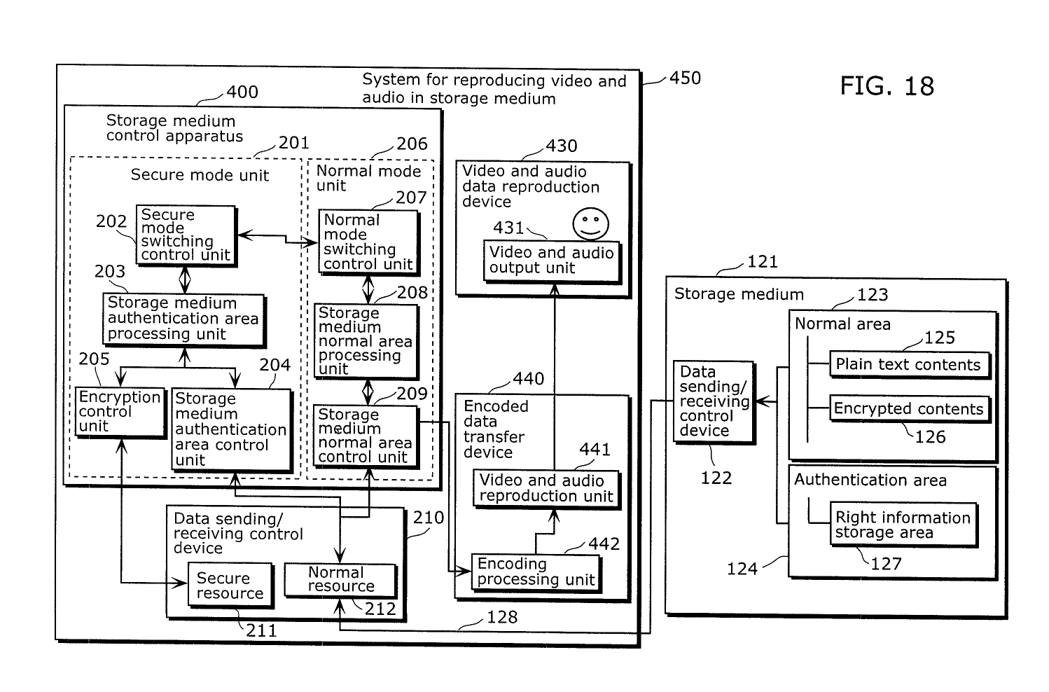

FIG. 18 is a diagram showing a configuration of a storage medium video and audio reproduction system according to the seventh embodiment.

A storage medium video and audio reproduction system 450 according to the seventh embodiment is a system for reproducing video and audio contents stored in a storage medium 121, and it is provided with a storage medium control device 400, a data sending/receiving control device 210, an encoded data transfer device 440, and a video and audio data reproduction device 430.

Components similar to the components in the embodiments described above are given the same reference numerals and names. Therefore, a detailed description thereof is not repeated here.

A normal resource 212 of the data sending/receiving control device 210 is connected to the storage medium 121 in which the video and audio contents are stored.

The storage medium control device 400 is provided with a secure mode unit 201 and a normal mode unit 206.

The encoded data transfer device 440 is provided with an encoding processing unit 442 and a video and audio reproduction unit 441.

The encoding processing unit 442 is a processing unit which analyzes an encoding format of the video and audio contents received from a storage medium normal area control unit 209, decodes the video and audio contents, and sends the video and audio data to the video and audio reproduction unit 441 in a particular data unit.

The video and audio reproduction unit 441 is a processing unit which receives the video and audio data from the encoding processing unit 442 in the particular data unit and reproduces the data.

The video and audio data reproduction device 430 is provided with a video and audio output unit 431.

The video and audio output unit 431 is a processing unit which outputs the video and audio data reproduced by the video and audio reproduction unit 441, and it is specifically a display device, a speaker, and the like.

The processings performed by the storage medium video and audio reproduction system 450 are similar to those described in the embodiments described above.

### Eighth Embodiment

The storage medium control apparatuses according to the embodiments described above are applicable to various equipment. In an eighth embodiment, the storage medium control system is applied to a system for recording video and audio contents.

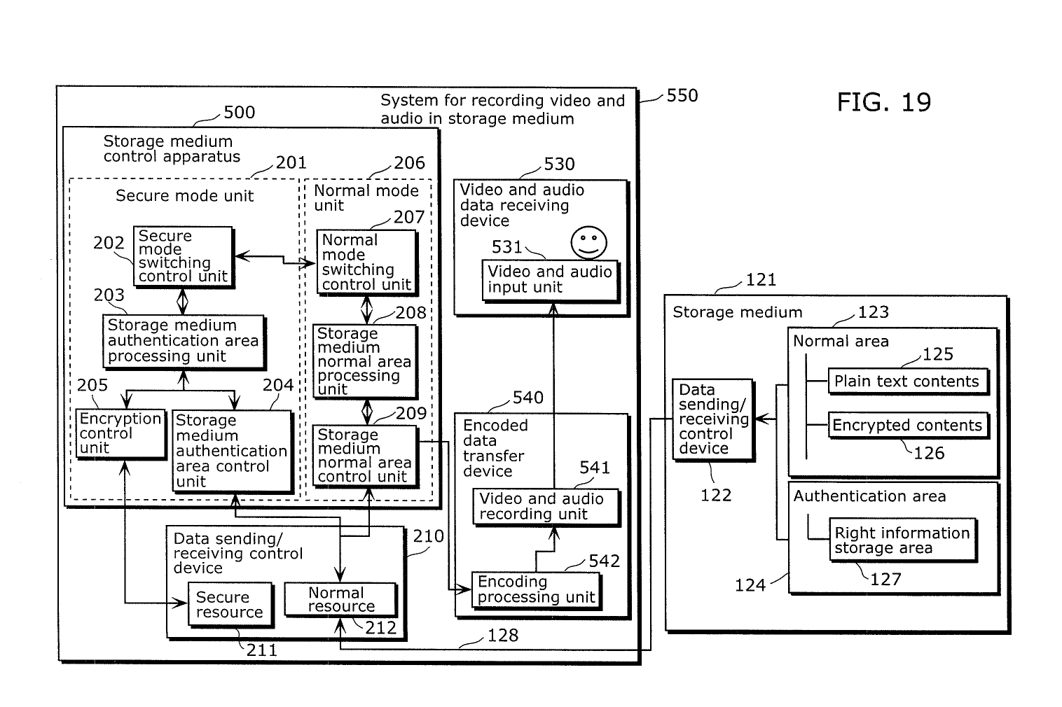

FIG. 19 is a diagram showing a configuration of a system for recording video and audio in a storage medium according to the eighth embodiment.

A system for recording video and audio in a storage medium 550 according to the eighth embodiment is a system for recording video and audio contents stored in a storage medium 121, and it is provided with a storage medium control device 500, a data sending/receiving control device 210, an encoded data transfer device 540, and a video and audio data receiving device 530.

Components similar to the components in the embodiments described above are given the same reference numerals and names. Therefore, a detailed description thereof is not repeated here.

A normal resource 212 of the data sending/receiving control device 210 is connected to the storage medium 121 in which the video and audio contents are stored.

The storage medium control device 500 is provided with a secure mode unit 201 and a normal mode unit 206.

The video and audio data receiving device 530 is provided with a video and audio input unit 531. The video and audio input unit 531 is a processing unit which receives, from other equipment or broadcast waves, video and audio data to be recorded.

The encoded data transfer device 540 is provided with a video and audio recording unit 541 and an encoding processing unit 542.

The video and audio recording unit 541 is a processing unit which receives the video and audio data from the video and audio input unit 531 for every particular data unit.

The encoding processing unit 542 is a processing unit which encodes the video and audio data received by the video and audio recording unit 541 on the basis of a particular encoding format.

The processings performed by the system for recording the video and audio in the storage medium 550 are similar to those described in the embodiments described above.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention is applicable to a system for reproducing or recording video and audio contents, and the like.

What is claimed is:

1. A storage medium control method for controlling data communication with a storage medium while switching between a secure mode in which use of a secure resource is permitted and a normal mode in which only use of a normal resource is permitted,
wherein the storage medium includes:
an authentication area which can be accessed after mutual authentication is performed; and
a normal area which can be accessed without performing the mutual authentication,
the secure resource is a module which executes mutual authentication processing with the authentication area of the storage medium,
the normal resource is a module which sends or receives data to or from the storage medium, and
said storage medium control method comprises a secure-mode data sending/receiving step of sending or receiving data to or from the storage medium by controlling of the normal resource without switching to the normal mode by a storage medium control unit which controls the storage medium, in the secure mode.

2. The storage medium control method according to claim 1,
wherein the secure resource further executes the mutual authentication processing with the authentication area of the storage medium,
said secure-mode data sending/receiving step includes a secure-mode encrypted/decrypted data sending/receiving step of sending or receiving the data to or from the storage medium by controlling of the normal resource without switching to the normal mode by the storage medium control unit which controls the storage medium, in the secure mode, the data being the data encrypted by an encryption control unit which controls encryption or decryption of data or the data to be decrypted by an encryption control unit; and
said storage medium control method further comprises:
a secure-mode encryption/decryption step of encrypting or decrypting data by controlling of the secure resource by the encryption control unit, in the secure mode; and
a secure-mode predetermined processing execution step of executing predetermined processing, by a storage medium processing unit, for the data decrypted in said secure-mode encrypting/decrypting step or unencrypted data read from the storage medium in said secure-mode encrypted/decrypted data sending/receiving step, in the secure mode.

3. The storage medium control method according to claim 2,
wherein the storage medium control unit includes:
a storage medium authentication area control unit operable to control the authentication area of the storage medium in the secure mode; and
a storage medium normal area control unit operable to control the normal area of the storage medium in the normal mode,
the storage medium processing unit includes:
a storage medium authentication area processing unit operable to execute predetermined processing for data in the secure mode; and
a storage medium normal area processing unit operable to execute predetermined processing for data in the normal mode,
in said secure-mode encrypted/decrypted data sending/receiving step, the data is sent to or received from the authentication area of the storage medium by controlling of the normal resource without switching to the normal mode by the storage medium authentication area control unit, in the secure mode, the data being the data encrypted by the encryption control unit or the data to be decrypted by the encryption control unit,
in said secure-mode predetermined processing execution step, the storage medium authentication area processing unit executes the predetermined processing for the data decrypted in said secure-mode encryption/decryption step or the unencrypted data read from the authentication area of the storage medium in said secure-mode encrypted/decrypted data sending/receiving step, in the secure mode, and
said storage medium control method further comprises:
a normal-mode data sending/receiving step of sending or receiving data to and from the normal area of the storage medium by controlling of the normal resource by the storage medium normal area control unit, in the normal mode; and
a normal-mode predetermined processing execution step of executing predetermined processing, by the storage medium normal area processing unit, for the data sent or received in said normal-mode data sending/receiving step, in the normal mode.

4. The storage medium control method according to claim 3, further comprising:
an initialization step of acquiring storage medium information including at least address information, area size or access size about the storage medium by executing initialization processing of the storage medium by the storage medium normal area control unit; and
a notification step of notifying the storage medium authentication area control unit of the storage medium information acquired in said initialization step,
wherein, in said secure-mode encrypted/decrypted data sending/receiving step, the data is sent to or received from the authentication area of the storage medium by controlling of the normal resource using the storage medium information without switching to the normal mode by the storage medium authentication area control unit, in the secure mode, the data being the data encrypted by the encryption control unit or the data to be decrypted by the encryption control unit.

5. The storage medium control method according to claim 3, further comprising:
an initialization step of acquiring storage medium information including at least address information, area size or access size about the storage medium by executing initialization processing of the storage medium, irrespective of whether or not the storage medium has already been executed, by the storage medium authentication area control unit, when transitioning to the secure mode,
wherein, in said secure-mode encrypted/decrypted data sending/receiving step, the data is sent to or received from the authentication area of the storage medium by controlling of the normal resource using the storage medium information without switching to the normal mode by the storage medium authentication area control unit, in the secure mode, the data being the data encrypted by the encryption control unit or the data to be decrypted by the encryption control unit.

6. The storage medium control method according to claim 3, further comprising:
an initialization step of acquiring storage medium information including at least address information, area size or access size about the storage medium by executing initialization processing of the storage medium by the storage medium normal area control unit;
an encryption step of encrypting, using a secret key, the storage medium information acquired in said initialization step;
a notification step of notifying the storage medium authentication area control unit of the encrypted storage medium information, the encrypted storage medium information being the storage medium information that has been encrypted; and
a decryption step of decrypting, using the secret key, the encrypted storage medium information by the storage medium authentication area control unit,
wherein, in said secure-mode encrypted/decrypted data sending/receiving step, the data is sent to or received from the authentication area of the storage medium by controlling of the normal resource using the storage medium information without switching to the normal mode by the storage medium authentication area control unit, in the secure mode, the data being the data encrypted by the encryption control unit or the data decrypted by the encryption control unit.

7. The storage medium control method according to claim 3, further comprising:
a step of judging, by the storage medium normal area processing unit, whether or not the storage medium normal area control unit is accessing the normal area of the storage medium;
a step of permitting the storage medium authentication area control unit to use the normal resource when it is judged that the normal area of the storage medium is not being accessed;
a step of judging, by the storage medium authentication area processing unit, whether or not the storage medium authentication area control unit is accessing the authentication area of the storage medium; and
a step of permitting the storage medium normal area control unit to use the normal resource when it is judged that the authentication area of the storage medium is not being accessed.

8. The storage medium control method according to claim 3, further comprising:
a step of judging a condition of access to the storage medium by referencing of storage medium access data indicating the condition of access to the storage medium by the storage medium authentication area control unit, the storage medium access data allowing referencing from both the storage medium authentication area control unit and the storage medium normal area control unit;
a step of permitting the storage medium authentication area control unit to use the normal resource when the storage medium authentication area control unit judges that the storage medium is not being accessed;
a step of judging a condition of access to the storage medium by referencing of the storage medium access data by the storage medium normal area processing unit; and
a step of permitting the storage medium normal area control unit to use the normal resource when the storage medium normal area control unit judges that the storage medium is not being accessed.

9. The storage medium control method according to claim 3, further comprising:
a step of resetting the normal resource by the storage medium normal area control unit or the storage medium authentication area control unit, each time mode switching between the secure mode and the normal mode occurs; and
a step of setting a set value including access bit width for accessing the storage medium or access size of data sent to or received from the storage medium for the normal resource by the storage medium normal area control unit or the storage medium authentication area control unit, the storage medium normal area control unit or the storage medium authentication area control unit resetting the normal resource,
wherein, in said secure-mode encrypted/decrypted data sending/receiving step, the data is sent to or received from the authentication area of the storage medium by controlling of the normal resource without switching to the normal mode, in accordance with the set value set for the normal resource, by the storage medium authentication area control unit, in the secure mode, the data being the data encrypted by the encryption control unit or the data to be decrypted by the encryption control unit, and
in said normal-mode data sending/receiving step, the data is sent to or received from the normal area of the storage medium by controlling of the normal resource, in accordance with the set value set for the normal resource, by the storage medium normal area control unit, in the normal mode.

10. The storage medium control method according to claim 3, further comprising:
a step of backing up, in a predetermined memory area, a set value including access bit width for accessing the storage medium or access size of data sent to or received from the storage medium when switching from the normal mode to the secure mode, the storage medium being used by the storage medium normal area control unit;
a step of setting the set value to be used by the storage medium authentication area control unit for the normal resource after the set value is backed up in the predetermined memory area; and
a step of setting the set value to be used by the storage medium normal area control unit for the normal resource when exiting the secure mode, the set value being backed up in the predetermined memory area,
wherein, in said secure-mode encrypted/decrypted data sending/receiving step, the data is sent to or received from the authentication area of the storage medium by controlling of the normal resource without switching to the normal mode, in accordance with the set value set for the normal resource, by the storage medium authentication area control unit, in the secure mode, the data being the data encrypted by the encryption control unit or the data to be decrypted by the encryption control unit, and
in said normal-mode data sending/receiving step, the data is sent to or received from the normal area of the storage medium by controlling of the normal resource, in accordance with the set value set for the normal resource, by the storage medium normal area control unit, in the normal mode.

11. The storage medium control method according to claim 3,
wherein the normal resource is connected to a set value storage unit which is a module storing a set value including access bit width for accessing the storage medium or access size of data sent to or received from the storage medium, the set value being used when the normal resource accesses the storage medium,
said storage medium control method further comprises a step of setting the set value stored in the set value storage unit for each mode by the normal resource, each time mode switching between the normal mode and the secure mode occurs,
in said secure-mode encrypted/decrypted data sending/receiving step, the data is sent to or received from the authentication area of the storage medium by controlling the normal resource without switching to the normal mode, in accordance with the set value set for the normal resource, by the storage medium authentication area control unit, in the secure mode, the data being the data encrypted by the encryption control unit or the data to be decrypted by the encryption control unit, and
in said normal-mode data sending/receiving step, data is sent to or received from the normal area of the storage medium by controlling of the normal resource, in accordance with the set value set for the normal resource, by the storage medium normal area control unit, in the normal mode.

12. The storage medium control method according to claim 3, further comprising:
a step of judging whether or not access to the storage medium is a first access after resetting of the storage medium by the storage medium normal area processing unit, when the access to the storage medium occurs;
a step of initializing the storage medium by the storage medium normal area processing unit when it is judged that the access is the first access after the resetting of the storage medium; and
a step of notifying the storage medium authentication area control unit of storage medium access information when the normal mode is switched to the secure mode, the storage medium access information being identification information identifying the storage medium and obtained along with the initialization of the storage medium,
wherein, in said secure-mode encrypted/decrypted data sending/receiving step, the data is sent to or received from the authentication area of the storage medium by controlling of the normal resource in accordance with the storage medium access information without switching to the normal mode by the storage medium authentication area control unit, in the secure mode, the data being the data encrypted by the encryption control unit or the data to be decrypted by the encryption control unit.

13. The storage medium control method according to claim 12, further comprising
a step of executing mutual authentication processing by the storage medium authentication area control unit, only when the mutual authentication processing with the authentication area of the storage medium has not succeeded at all after the resetting of the storage medium, with the authentication area of the storage medium, in the secure mode.

14. The storage medium control method according to claim 12,
wherein the resetting of the storage medium is caused by the storage medium being on or off, the storage medium being inserted or removed, or occurrence of an abnormal state.

15. The storage medium control method according to claim 3, further comprising:
a step of initializing the storage medium by the storage medium normal area control unit, each time a request to access the storage medium occurs; and
a step of notifying the storage medium authentication area control unit of storage medium access information when the normal mode is switched to the secure mode, the storage medium access information being identification information for identifying the storage medium and obtained along with the initialization of the storage medium,
wherein, in said secure-mode encrypted/decrypted data sending/receiving step, the data is sent to or received from the authentication area of the storage medium by controlling of the normal resource without switching to the normal mode, in accordance with the storage medium access information, by the storage medium authentication area control unit, in the secure mode, the data being the data encrypted by the encryption control unit or the data to be decrypted by the encryption control unit.

16. A storage medium control apparatus which controls data communication with a storage medium while switching between a secure mode in which use of a secure resource is permitted and a normal mode in which only use of a normal resource is permitted,
wherein the storage medium includes:
an authentication area which can be accessed after mutual authentication is performed; and
a normal area which can be accessed without performing the mutual authentication, and
said storage medium control apparatus comprises:
said secure resource which executes mutual authentication processing with the authentication area of the storage medium, and encryption or decryption of data;
said normal resource which sends or receives data to or from the storage medium;
an encryption control unit operable to execute encryption or decryption of data by controlling the secure resource in the secure mode;
a storage medium control unit operable to send or receive data to or from the storage medium by controlling of said normal resource without switching to the normal mode, in the secure mode, the data being the data encrypted by said encryption control unit or data to be decrypted by said encryption control unit; and
a storage medium processing unit operable to execute predetermined processing for the data decrypted by said encryption control unit or unencrypted data read from the storage medium by said storage medium control unit, in the secure mode.

17. The storage medium control apparatus according to claim 16,
wherein the storage medium control unit includes:
a storage medium authentication area control unit operable to send or receive data to or from the authentication area of the storage medium by controlling of the normal resource, in the secure mode, the data being the data encrypted by the encryption control unit or the data to be decrypted by the encryption control unit; and
a storage medium normal area control unit operable to send or receive data to or from the normal area of the storage medium by controlling of the normal resource, in the normal mode, and
the storage medium processing unit includes:
a storage medium authentication area processing unit operable to execute predetermined processing for the data decrypted by the encryption control unit or unencrypted data read from the authentication area of the storage medium by the storage medium authentication area control unit, in the secure mode; and
a storage medium normal area processing unit operable to execute predetermined processing for the unencrypted data read from the normal area of the storage medium by the storage medium normal area control unit, in the normal mode.

18. The storage medium control apparatus according to claim 17, further comprising:
an encoding processing unit operable to receive video/audio contents from the storage medium normal area control unit, analyze an encoding format of the received video/audio contents, decode the video/audio contents, and output video/audio data in particular data unit; and
a video/audio reproduction unit operable to receive and reproduce the video/audio data outputted from the encoding processing unit in the particular data unit.

19. The storage medium control apparatus according to claim 17, further comprising:
a video/audio recording unit operable to receive video/audio data in particular data unit; and
an encoding processing unit operable to encode the video/audio data received by the video/audio recording unit on the basis of a particular encoding format, and output the data to the storage medium normal area control unit.

20. A program for causing a computer to function as a storage medium control apparatus which controls data communication with a storage medium while switching between a secure mode in which use of a secure resource is permitted and a normal mode in which only use of a normal resource is permitted,
wherein the storage medium includes:
an authentication area which can be accessed after mutual authentication is performed; and
a normal area which can be accessed without performing the mutual authentication, and
the program causes the computer to function as:
the secure resource which executes mutual authentication processing with the authentication area of the storage medium, and encryption or decryption of data;
the normal resource which sends or receives data to or from the storage medium;
an encryption control unit operable to execute encryption or decryption of data by controlling the secure resource in the secure mode;
a storage medium control unit operable to send or receive data to or from the storage medium by controlling of the normal resource without switching to the normal mode, in the secure mode, the data being the data encrypted by the encryption control unit or data to be decrypted by the encryption control unit; and
a storage medium processing unit operable to execute predetermined processing for the data decrypted by the encryption control unit or unencrypted data read from the storage medium by the storage medium control unit.
